(19) United States
(12) Patent Application Publication
(10) Pub. No.: US 2015/0067540 A1
(43) Pub. Date: Mar. 5, 2015

(54) DISPLAY APPARATUS, PORTABLE DEVICE AND SCREEN DISPLAY METHODS THEREOF

(71) Applicant: Samsung Electronics Co., Ltd., Suwon-si (KR)

(72) Inventors: Pil-seung YANG, Seoul (KR); Chan-hong MIN, Yongin-si (KR); Young-ah SEONG, Seoul (KR); Say JANG, Yongin-si (KR)

(73) Assignee: SAMSUNG ELECTRONICS CO., LTD., Suwon-si (KR)

(21) Appl. No.: 14/473,341

(22) Filed: Aug. 29, 2014

(30) Foreign Application Priority Data
Sep. 2, 2013 (KR) 10-2013-0104965

(51) Int. Cl. G06F 3/0484; H04L 12/18; G06F 3/0486

(52) U.S. Cl. CPC G06F 3/04842; G06F 3/0486; H04L 12/1822
USPC 715/753

(57) ABSTRACT

A portable device and screen display methods of a display apparatus connectable to a portable device are provided. The method includes displaying a collaborative screen including a plurality of operation areas on the display apparatus; allocating at least one of the operation areas to the portable device; displaying the collaborative screen with the allocated operation area being distinguishable; and giving notification so that the allocated operation area is displayed on a corresponding portable device.

### CROSS-REFERENCE TO RELATED APPLICATION

This application claims priority from Korean Patent Application No. 10-2013-0104965, filed on Sep. 2, 2013 in the Korean Intellectual Property Office, the disclosure of which is incorporated herein by reference in its entirety.

### BACKGROUND

1. Field

Methods and apparatuses consistent with the exemplary embodiments relate to a display apparatus, a portable device and screen display methods thereof, and more particularly to a display apparatus, a portable device and screen display methods which enable mutual sharing of a screen.

2. Description of the Related Art

In recent years, portable devices, including smartphones and tablet personal computers (PCs), which provide a variety of extended services and functions have been developed, and are used widely. For example, technologies which enable one portable device to share data, such as music and videos, with other portable devices or enable one portable device to control other portable devices, for example, to play back a video, have been developed in response to the improvement of wireless networks and diverse user demands. Accordingly, there are increasing demands for techniques for sharing data between a plurality of portable devices or between a portable device and a communal control device, or techniques for displaying a screen on a main controller or another portable device for controlling a portable device and using the screen displayed on the other portable device.

Further, as interests in building a smart education environment using an interactive whiteboard and portable equipment rise, demands for the interactive whiteboard and portable equipment also increase accordingly. However, inconvenience in manipulating the equipment may interrupt a class and thus improvement in manipulation is increasingly needed.

### SUMMARY

An aspect of one or more exemplary embodiments provides a screen display method of a display apparatus connectable to a portable device, the method comprising: displaying a collaborative screen comprising a plurality of operation areas on the display apparatus; allocating at least one of the operation areas to the portable device; displaying the collaborative screen with the allocated operation area; and giving a notification so that the allocated operation area is displayed on a corresponding portable device.

The method may further comprise storing collaborative screen information including information on the allocated operation area.

The collaborative screen information may be stored in a storage of the display apparatus or a server connectable to the display apparatus.

The method may further comprise receiving operation information on the collaborative screen from the portable device, and updating the stored collaborative screen information based on the received operation information.

The method may further comprise setting a size of the collaborative screen, and generating the collaborative screen with the set size.

According to an aspect of the exemplary embodiment, the operation area may be allocated to a plurality of portable devices, and a plurality of users corresponding to the portable devices may be included in one group.

The method may further comprise detecting a user touch on a screen of a touchscreen of the display apparatus, and controlling the collaborative screen corresponding to the touch.

According to an aspect of the exemplary embodiment, the controlling of the collaborative screen may include enlarging or reducing the collaborative screen on the display corresponding to a zoom in/out manipulation when the user touch is the zoom in/out manipulation using a multi-touch operation.

According to an aspect of the exemplary embodiment, the controlling of the collaborative screen may include moving the collaborative screen on the display corresponding to a moving direction of the user touch when the user touch is a flick or a drag.

According to an aspect of the exemplary embodiment, the controlling of the collaborative screen comprises moving or copying an operation area set in a first location to a second location when the user touch is a drag and drop of the operation areas from the first location to the second location different from the first location.

According to an aspect of the exemplary embodiment, the operation area set in the first location may be copied to the second location when the user touch is a drag and drop from the first location to the second location while holding the touch at the first location.

According to an aspect of the exemplary embodiment, the controlling of the collaborative screen may comprise displaying a first area as a full screen of the display apparatus when the user touch is a tap on the first area among the operations areas.

According to an aspect of the exemplary embodiment, the method may further comprise displaying the collaborative screen including the operation areas on the display apparatus when a menu at a preset location is selected in the first area displayed as the full screen.

Another aspect of one or more exemplary embodiments provides a screen display method of a portable device connectable to a display apparatus and another portable device, the method comprising: displaying a collaborative screen including a plurality of operation areas on the portable device; allocating at least one of the operation areas to the other portable device; displaying the collaborative screen with the allocated operation area being distinguishable; and giving notification so that the allocated operation area is displayed on the corresponding other portable device.

According to an aspect of the exemplary embodiment, the method may further include transmitting collaborative screen information including information on the allocated operation area.

According to an aspect of the exemplary embodiment, the collaborative screen information may be transmitted to the display apparatus or a server managing the collaborative screen information.

According to an aspect of the exemplary embodiment, the method may further comprise receiving operation information on the collaborative screen, updating the pre-stored collaborative screen information based on the received operation information, and transmitting the updated collaborative screen information.

According to an aspect of the exemplary embodiment, the method may further comprise setting a size of the collaborative screen, and generating the collaborative screen with the set size.

According to an aspect of the exemplary embodiment, the operation area may be allocated to a plurality of other portable devices, and a plurality of users corresponding to the portable devices may be included in one group.

According to an aspect of the exemplary embodiment, the method may further comprise detecting a user touch on a touchscreen of the portable device, and controlling the collaborative screen corresponding to the detected user touch.

According to an aspect of the exemplary embodiment, the controlling of the collaborative screen may comprise enlarging or reducing the collaborative screen on a display corresponding to a zoom in/out manipulation when the user touch is the zoom in/out manipulation using a multi-touch.

According to another aspect of the exemplary embodiment, the controlling of the collaborative screen may comprise moving the collaborative screen on the display corresponding to a moving direction of the user touch when the user touch is a flick or a drag.

According to an aspect of the exemplary embodiment, the controlling of the collaborative screen may include moving or copying an operation area set in a first location to a second location when the user touch is a drag and drop of the operation areas from the first location to the second location different from the first location.

According to another aspect of the exemplary embodiment, the operation area set in the first location may be copied to the second location when the user touch is a drag and drop operation from the first location to the second location while holding the touch at the first location.

According to another aspect of the exemplary embodiment, the controlling of the collaborative screen may include displaying a first area as a full screen of the touch screen when the user touch is a tap on the first area among the operations areas.

According to an aspect of the exemplary embodiment, the method may further include reducing the screen on the display so that part of the operation areas adjacent to the first area is displayed on the touchscreen when a back operation is selected from a menu at a location of the first area displayed as the full screen.

According to an aspect of the exemplary embodiment, the method may further comprise receiving a user input on a second area among the operation areas, selecting a menu icon disposed at a location of the screen of the touch screen, and registering the second area as a bookmark.

According to an aspect of the exemplary embodiment, the method may further include displaying a plurality of bookmark items corresponding to the selecting of the menu icon, and the registering as the bookmark may comprise conducting a drag operation from the menu icon to one of the bookmark items.

According to another aspect of the exemplary embodiment, the method may further comprise selecting the menu icon disposed at a location of the screen of the touch screen, displaying the plurality of bookmark items corresponding to the selecting of the menu icon, selecting one of the displayed bookmark items, and displaying an operation area corresponding to the selected bookmark item on the screen of the touchscreen.

According to an aspect of the exemplary embodiment, the method may further comprise receiving a user input on a third area among the operation areas, detecting that a front side and a rear side of the portable device are overturned, and transmitting a command to lock the third area.

According to an aspect of the exemplary embodiment, the method may further comprise receiving a user input on a fourth area among the operation areas, detecting that the transmission of light to a luminance sensor of the portable device is blocked, and transmitting a command to hide the fourth area.

The foregoing and/or other aspects may be achieved by providing a display apparatus connectable to a portable device, the display apparatus comprising: a communication device configured to conduct communications with an external device; a display configured to display a collaborative screen comprising a plurality of operation areas; an input configured to allocate at least one of the operation areas to the portable device; and a controller configured to control the display to display the collaborative screen with the allocated operation area being distinguishable and configured to control the communication device to give a command to display the allocated operation area on a corresponding portable device.

According to an aspect of the exemplary embodiment, the display apparatus may further comprise a storage configured to store collaborative screen information including information on the allocated operation area.

According to an aspect of the exemplary embodiment, the communication device is configured to receive operation information on the collaborative screen from the portable device, and the controller is configured to update the collaborative screen information stored in the storage based on the received operation information.

According to an aspect of the exemplary embodiment, the controller is configured to control the communication device to transmit the collaborative screen information including the information on the allocated operation area to a server connectable to the display apparatus.

According to an aspect of the exemplary embodiment, the input is configured to receive a set size of the collaborative screen, and the controller is configured to generate the collaborative screen with the set size.

According to an aspect of the exemplary embodiment, the operation area may be allocated to a plurality of portable devices, and a plurality of users corresponding to the portable devices may be included in one group.

According to an aspect of the exemplary embodiment, the controller is configured to detect a user touch on a touchscreen of the display and is configured to control the display to control the collaborative screen corresponding to the touch.

According to an aspect of the exemplary embodiment, the controller is configured to control the display to enlarge or reduce the collaborative screen on the display corresponding to a zoom in/out manipulation when the user touch is the zoom in/out manipulation using a multi-touch operation.

According to an aspect of the exemplary embodiment, the controller is configured to control the display to move the collaborative screen on the display corresponding to a moving direction of the user touch when the user touch is a flick operation or a drag operation.

According to an aspect of the exemplary embodiment, the controller is configured to control the display to move or copy an operation area set in a first location to a second location when the user touch is a drag and drop of the operation areas from the first location to the second location different from the first location.

According to an aspect of the exemplary embodiment, the controller is configured to control the display to copy the operation area set in the first location to the second location when the user touch is a drag and drop from the first location to the second location while holding the touch at the first location.

According to an aspect of the exemplary embodiment, the controller is configured to control the display to display a first area as a full screen of the display when the user touch is a tap operation on the first area among the operations areas.

According to an aspect of the exemplary embodiment, the controller is configured to control the display to display the collaborative screen including the operation areas on the display apparatus when a menu disposed at a preset location is selected in the first area displayed as the full screen.

Another aspect of one or more exemplary embodiments provides a portable device connectable to a display apparatus and another portable device, the portable device comprising: a communication device configured to conduct communications with an external device; a display configured to display a collaborative screen including a plurality of operation areas; an input configured to allocate at least one of the operation areas to the portable device; and a controller configured to control the display to display the collaborative screen with the allocated operation area being distinguishable and configured to control the communication device to give a command to display the allocated operation area on a corresponding portable device.

According to an aspect of the exemplary embodiment, the communication device is configured to transmit collaborative screen information including information on the allocated operation area.

According to an aspect of the exemplary embodiment, the collaborative screen information may be transmitted to the display apparatus or a server managing the collaborative screen information.

According to an aspect of the exemplary embodiment, the input is configured to receive operation information on the collaborative screen, and the controller is configured to control the display to update and display the pre-stored collaborative screen information based on the received operation information and configured to control the communication device to transmit the updated collaborative screen information.

According to an aspect of the exemplary embodiment, the input is configured to set a size of the collaborative screen, and the controller is configured to generate the collaborative screen with the set size.

According to an aspect of the exemplary embodiment, the operation area may be allocated to a plurality of other portable devices, and a plurality of users corresponding to the portable devices may be included in one group.

According to an aspect of the exemplary embodiment, the controller comprises a touchscreen controller configured to detect a user touch on a screen of a touchscreen of the display and configured to control the collaborative screen corresponding to the touch.

According to an aspect of the exemplary embodiment, the controller is configured to control the display to enlarge or reduce the collaborative screen on the display corresponding to a zoom in/out manipulation when the users touch is the zoom in/out manipulation using a multi-touch.

According to an aspect of the exemplary embodiment, the controller is configured to control the display to move the collaborative screen on display corresponding to a moving direction of the user touch when the user touch is a flick operation or a drag operation.

According to an aspect of the exemplary embodiment, the controller is configured to control the display to move or copy an operation area set in a first location to a second location when the user touch is a drag and drop of the operation areas from the first location to the second location different from the first location.

According to an aspect of the exemplary embodiment, the controller is configured to control the display to copy the operation area set in the first location to the second location when the user touch is a drag and drop from the first location to the second location while holding the touch at the first location.

According to an aspect of the exemplary embodiment, the controller is configured to control the display to display a first area as a full screen of the touch screen when the user touch is a tap on the first area among the operations areas.

According to an aspect of the exemplary embodiment, the controller is configured to control the display to reduce the screen on display so that part of operation areas adjacent to the first area is displayed on the touchscreen when a back is selected through the input from a menu disposed at a location of the first area displayed as the full screen.

According to an aspect of the exemplary embodiment, the controller is configured to register a second area as a bookmark when a user input on the second area among the operation areas is received from the input and a menu icon disposed at a location of the screen of the touch screen is selected.

According to an aspect of the exemplary embodiment, the controller is configured to display a plurality of bookmark items on the display corresponding to the selected, detect a drag operation from the menu icon to one of the bookmark items menu icon, and register the bookmark.

According to an aspect of the exemplary embodiment, the controller is configured to control the display to display the plurality of bookmark items corresponding to the selected menu icon when the menu icon disposed at the location of the screen of the touch screen is selected through the input, and control the display to display an operation area corresponding to the selected bookmark item on the screen of the touchscreen when one of the displayed bookmark items is selected through the input.

According to an aspect of the exemplary embodiment, the controller is configured to control the communication device to transmit a command to lock the operation area displayed on the display when it is detected that a front side and a rear side of the portable device are overturned.

According to an aspect of the exemplary embodiment, the controller is configured to control the communication device to transmit a command to hide the operation area displayed on the display when it is detected that transmission of light to a luminance sensor of the portable device is blocked.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram illustrating a configuration of a cooperative learning system according to an exemplary embodiment.

FIG. 2 is a block diagram illustrating a configuration of a cooperative learning system according to another exemplary embodiment.

FIG. 3 schematically illustrates a display apparatus according to an exemplary embodiment.

FIG. 4 is a block diagram illustrating a configuration of the display apparatus of FIG. 3.

FIG. 5 is a front perspective view schematically illustrating a portable device according to an exemplary embodiment.

FIG. 6 is a rear perspective view schematically illustrating the portable device according to an exemplary embodiment.

FIG. 7 is a block diagram illustrating a configuration of the portable device shown in FIGS. 5 and 6.

FIGS. 8 to 10 illustrate a process of generating a collaborative screen and allocating an operation area according to an exemplary embodiment.

FIG. 11 illustrates an example of moving a screen of a touchscreen display device according to the exemplary embodiment.

FIG. 12 schematically illustrates a process of transmitting and receiving data for controlling the touchscreen based on a user touch according to an exemplary embodiment.

FIG. 13 illustrates an example of enlarging and reducing the screen of the touchscreen display device according to an exemplary embodiment.

FIGS. 14 and 15 illustrate an example of reducing and moving the screen using a back button according to an exemplary embodiment.

FIGS. 16 and 17 illustrate an example of registering an operation area as a bookmark and moving or jumping to an operation area in a previously registered bookmark.

FIGS. 18 and 19 illustrate examples of moving and copying an operation area according to an exemplary embodiment.

FIGS. 20 and 21 illustrate examples of locking and hiding an operation area according to an exemplary embodiment.

FIG. 22 schematically illustrates a process of transmitting and receiving an area control signal based on a user touch according to an exemplary embodiment.

FIGS. 23 to 26 illustrate that the display apparatus displays a screen using a menu icon according to an exemplary embodiment.

FIG. 27 is a flowchart illustrating a screen display method according to an exemplary embodiment.

### DETAILED DESCRIPTION OF EXEMPLARY EMBODIMENTS

Below, exemplary embodiments will be described in detail with reference to the accompanying drawings.

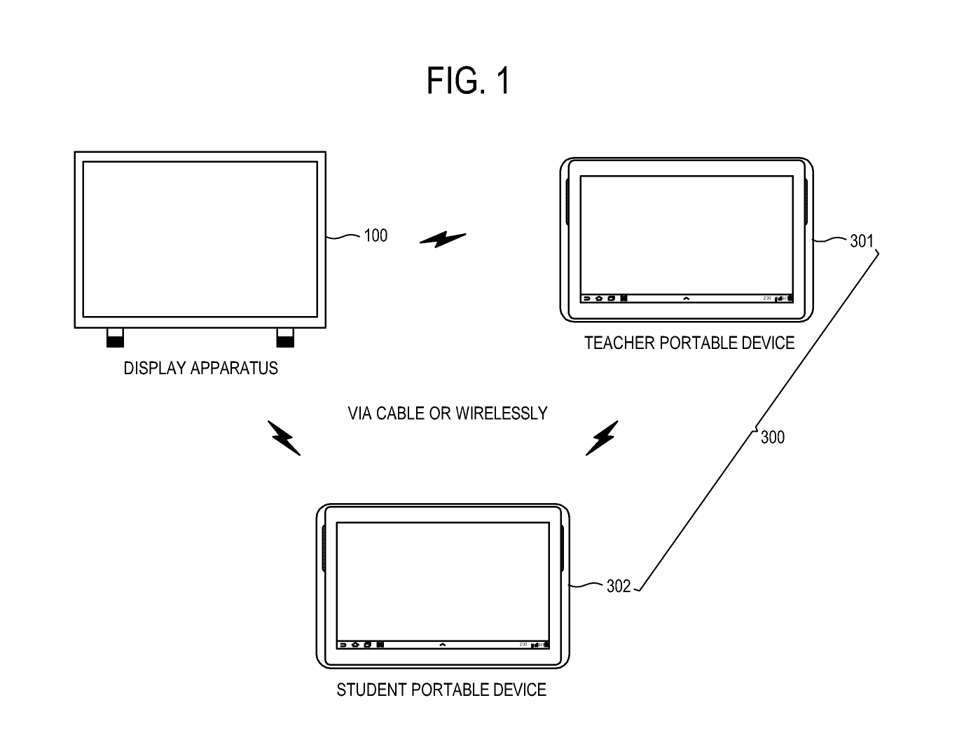

FIG. 1 is a block diagram illustrating a configuration of a cooperative learning system according to an exemplary embodiment.

The cooperative learning system enables individual students in a classroom, or small groups of students in the classroom to work on classroom activities together, that is, to perform cooperative learning or collaborative learning as an educational method, so as to complete tasks collectively towards achieving academic goals. As shown in FIG. 1, the cooperative learning system includes a display apparatus 100 and a plurality of portable devices 300.

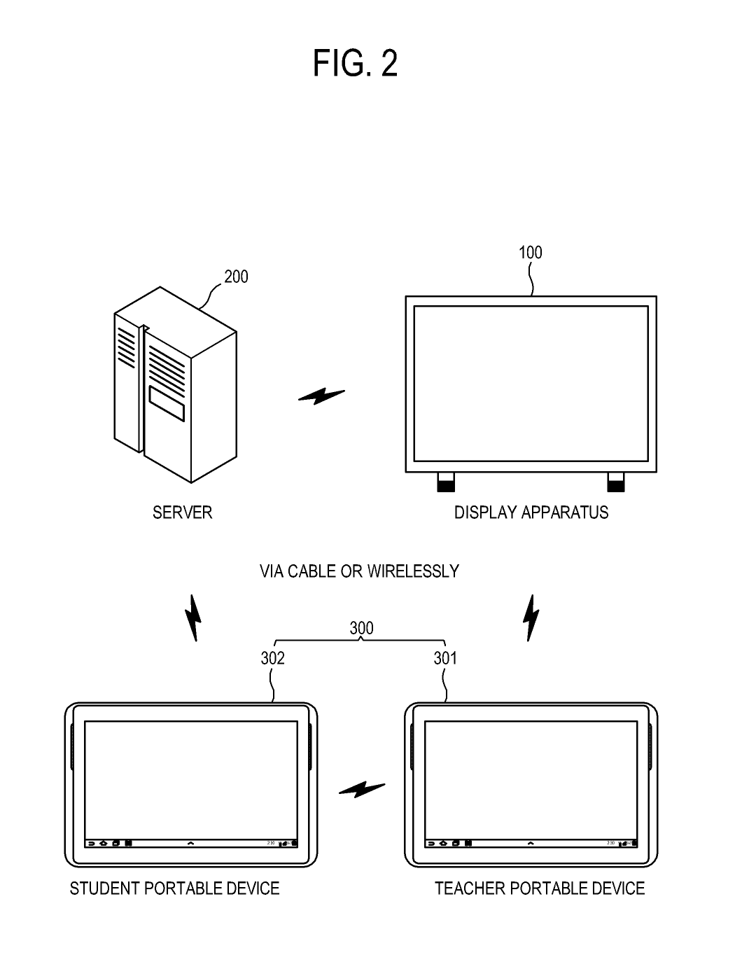

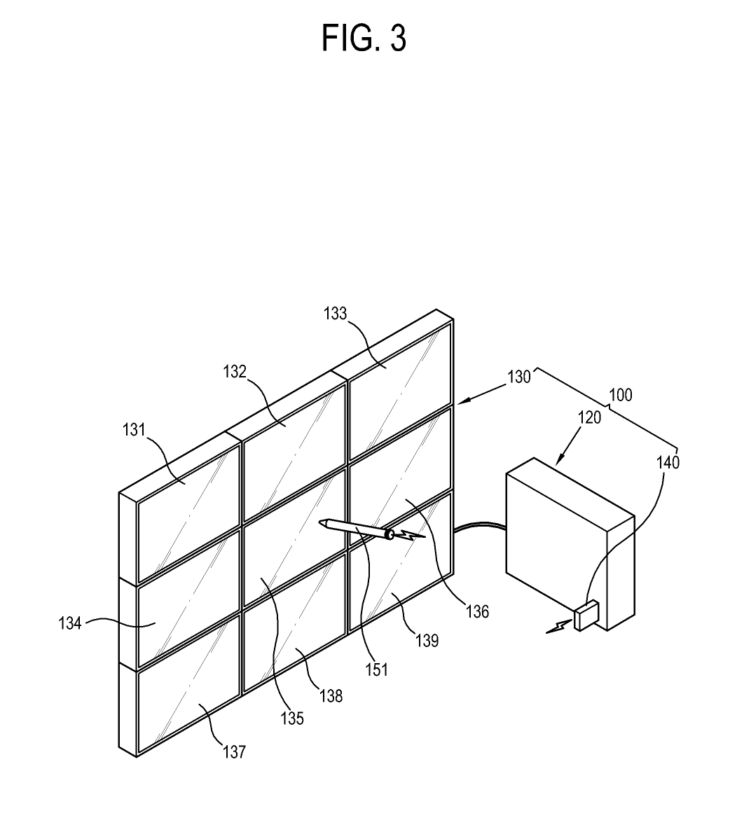

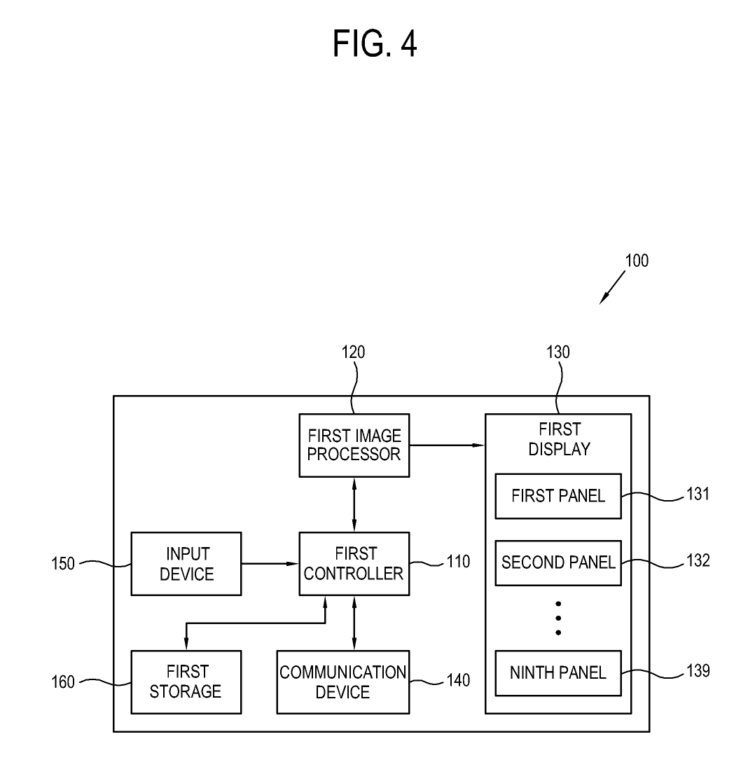

The display apparatus 100 is configured as an interactive whiteboard (IWB) and displays a collaborative screen for cooperative learning on a display 130 as shown in FIGS. 3 and 4. The display may include a touchscreen. A configuration of the display apparatus 100 shown in FIGS. 1 and 2 is applied the same to the IWB. The display apparatus of FIG. 1 stores various kinds of information including operation area information on the collaborative screen, and is shared between users of the portable devices 300. The users may be teachers and/or students, but are not limited thereto. The information stored in the display apparatus 100 may be accessed and updated via the portable devices 300.

The display apparatus 100 is a collaborative device that monitors operations according to the cooperative learning, displays a status of the entire collaborative screen, provides an interface for managing the collaborative screen including each operation area and may provide a presentation function after a cooperative learning class.

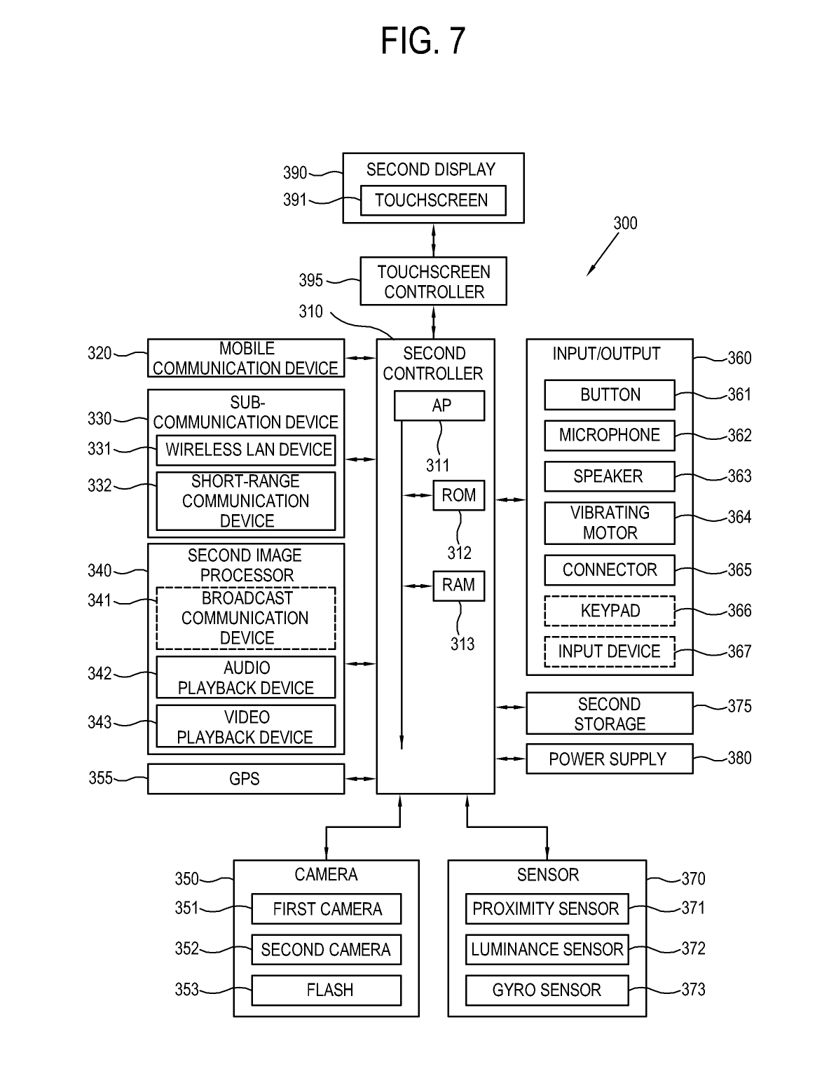

The portable devices 300 are configured as a digital device including a tablet PC, and display an allocated operation area of the collaborative screen on a display 390, which includes a touchscreen 391 as shown in FIG. 7. In the present exemplary embodiment, the portable devices 300 may include a teacher portable device 301 for monitoring the cooperative learning and at least one student portable device 302 used to conduct assignments on an allocated operation area for performing the cooperative learning.

The portable devices 300, which act as personal devices for performing cooperative work according to the cooperative learning, are allocated an operation area of the collaborative screen to manipulate and manage the operation area according to an instruction from a user, and move the operation area on the display to enable the cooperative learning.

The display apparatus 100, the teacher portable device 301 and the student portable device 302 are connected to one another via a cable or wireless communication.

FIG. 2 is a block diagram illustrating a configuration of a cooperative learning system according to another exemplary embodiment.

As compared with the cooperative learning system of FIG. 1, the cooperative learning system of FIG. 2 according to the present exemplary embodiment further includes a server 200 (hereinafter, also referred to as an “administration server”) to store information. Thus, other components than the server 200 are represented by the same reference numerals and the same terms as used for equivalent components shown in FIG. 1, and descriptions thereof will be omitted to avoid redundancy.

As shown in FIG. 2, the server 200 stores various kinds of information including operation area information on the collaborative screen, and is shared between users of the portable devices 300, which may be teachers and/or students. The information stored in the display apparatus 100 may be accessed and updated via the portable devices 300 including the teacher portable device 301 and the student portable device 302.

The server 200, as an administrator server to manage the collaborative screen, generates, modifies and deletes the collaborative screen corresponding to a user manipulation, and provides information for displaying the collaborative screen to the display apparatus 100. Also, the server 200 allocates an operation area within the collaborative screen to a personal device, that is, the portable devices 300, in a classroom. However, the location of the portable devices is not limited to classrooms. The portable devices may be utilized in other locations such as, for example, offices.

The display apparatus 100, the server 200, the teacher portable device 301 and the student portable device 302 are connected to one another via cable or wireless communication.

Information in the server 200 or a first storage 160 is stored and managed by file type and history according to a progression of cooperative learning. Thus, a teacher loads the stored information onto the display apparatus 100 or the teacher portable device 301 to look back into the progression of the cooperative learning on a time axis or to monitor each particular operation area.

In the cooperative learning system shown in FIG. 1 or FIG. 2, the teacher loads a collaborative subject onto one area or corner of the collaborative screen of the display apparatus 100. The teacher may also load the collaborative subject onto the student portable device 302 to make students aware of the subject, and allocates operation areas to students to share responsibilities. The students perform allocated operations using the portable device 302. The operation areas may be allocated by group or team, and a team leader is also allocated an operation area to write a presentation page based on operations of team members. When the allocated operations of the students are completed, operation results are transferred to the operation area allocated to the team leader to complete the presentation page. A presenter may enlarge a presentation page area to full screen on the display apparatus and give a presentation on the operation results by team or individual member.

FIG. 3 schematically illustrates a display apparatus 100 according to an exemplary embodiment, and FIG. 4 is a block diagram illustrating a configuration of the display apparatus 100 of FIG. 3.

As shown in FIG. 3, the display apparatus 100 according to the present exemplary embodiment includes a first display 130 to display an image and a touch input device 150, for example, a pointing device, as an input device used to touch a predetermined position on the first display 130.

The display apparatus 100 may be provided, for example, as a television (TV) or computer monitor including the display 130, without being limited particularly. In the present exemplary embodiment, however, the display apparatus 100 is provided as an IWB adopting a display 130 including a plurality of display panels 131 to 139 so as to realize a large-sized screen.

The display panels 131 to 139 may be disposed to stand upright against a wall or on a ground, being parallel with each other in a matrix form.

Although FIGS. 3 and 4 illustrate that the display unit 130 includes nine display panels 131 to 139, such a configuration is just an example. Alternatively, a number of display panels 131 to 139 may be changed variously. Here, each of the display panels 131 to may be touched on a surface with the input device 150 or a user's finger.

FIG. 3 shows that an image processor 120 and the display 130 of the display apparatus are separated from each other. The image processor 120 may be provided, for example, in a computer main body, such as a desktop computer and a laptop computer.

In this instance, a communication device 140 in a form of a dongle or module may be mounted on the image processor 120, and the display apparatus 100 may communicate with an external device including a server 200 and a portable device 300 through the communication device 140. Further, the communication device 140 may communicate with the input device 150 so as to receive a user input through the input device 150.

However, the foregoing configuration may be changed and modified in designing the apparatus, for example, the image processor 120 and the display 130 may be accommodated in a single housing (not shown). In this case, the communication device 140 may be embedded in the housing.

As shown in FIG. 4, the display apparatus 100 according to the present exemplary embodiment includes a first controller 110 to control all operations of the display apparatus 100, a first image processor 120 to process an image signal according to a preset image processing process, the first display 130 including the plurality of display panels 131 to 139 and displaying an image signal processed by the image processor 120, the communication device 140 to communicate with an external device, the input device 150 to receive a user input, and a first storage 160 to store various types of information including operation area information.

Here, the first storage 160 may store various types of information for cooperative learning as described above in the cooperative learning system of FIG. 1, without being limited thereto. For example, when the separate administration server 200 is provided as in the exemplary embodiment of FIG. 2, such information may be stored in the administration server 200. In this instance, the display apparatus 100 may access the information stored in the administration server through the communication device 140, and a corresponding collaborative screen may be displayed on the first display 130.

The first storage 160 may store a graphic user interface (GUI) associated with a control program for controlling the display apparatus 100 and applications provided by a manufacturer or downloaded externally, images for providing the GUI, user information, a document, databases or relevant data. The first controller 110 may implement an operating system (OS) and a variety of applications stored in the first storage 160.

The display 130 includes a touchscreen to receive an input based on a user's touch. Here, the user's touch includes a touch made by a user's body part, for example, a finger including a thumb or a touch made by touching the input device 151. In the present exemplary embodiment, the touchscreen of the first display 130 may receive a single touch or multi-touch input. The touchscreen may include, for instance, a resistive touchscreen, a capacitive touchscreen, an infrared touchscreen and an acoustic wave touchscreen, but is not limited thereto.

The input device 150 transmits various preset control commands or information to the first controller 110 according to a user input including a touch input. The input device 150 according to the present exemplary embodiment may include the input device 150 which enables a touch input. The input device 150 may include a pointing device, a stylus, and a haptic pen with an embedded pen vibrating element, for example, a vibration motor or an actuator, vibrating using control information received from the communication device 140. The vibrating element may also vibrate using sensing information detected by a sensor (not shown) embedded in the input device 150, for instance, an acceleration sensor, instead of the control information received from the display apparatus 100. The user may select various GUIs, such as texts and icons, displayed on the touchscreen for user's selection using the input device 150 or a finger.

The first controller 110 displays the collaborative screen for cooperative learning on the touchscreen of the first display 130, and controls the first image processor 120 and the first display 130 to display an image corresponding to a user manipulation or a user touch on the displayed collaborative screen.

In detail, the first controller 110 detects a user touch on the touchscreen of the first display 130, identifies a type of a detected touch input, derives coordinate information on x and y coordinates of a touched position and forwards the derived coordinate information to the image processor 120. Subsequently, an image corresponding to the type of the touch input and the touched position is displayed by the image processor 120 on the first display 130. Here, the image processor 120 may determine a display panel, for example, panel 135, is touched by the user among the display panels 131 to 139, and displays the image on the touched display panel 135.

The user touch includes a drag, a flick, a drag and drop, a tap and a long tap. However, the user touch is not limited thereto, and other touches such as a double tap and a tap and hold may be applied.

A drag refers to a motion of the user holding a touch on the screen using a finger or the touch input device 151 while moving the touch from one location to another location on the screen. A selected object may be moved by a drag motion. Also, when a touch is made and dragged on the screen without selecting an object on the screen, the screen is changed or a different screen is displayed based on the drag.

A flick is a motion of the user dragging a finger or the touch input device 151 at a threshold speed or higher, for example, 100 pixel/s. A flick and a drag may be distinguished from each other by comparing a moving speed of the finger or the input device with the threshold speed thereof, for example, 100 pixel/s.

A drag and drop operation is a motion of the user dragging a selected object using a finger or the touch input device 150 to a different location on the screen and releasing the object. A selected object is moved to a different location by a drag and drop operation.

A tap is a motion of the user quickly touching the screen using a finger or the touch input device 151. A tap is a touching motion made with a very short gap between a moment when the finger or the touch input device 150 comes in contact with the screen and a moment when the finger or the touch input device 150 touching the screen is separated from the screen.

A long tap is a motion of the user touching the screen for a predetermined period of time or longer using a finger or the touch input device 150. A long tap is a touching motion made with a gap between a moment when the finger or the touch input device 150 comes in contact with the screen and a moment when the finger or the touch input device 150 touching the screen is separated from the screen longer than the gap of the tap. The first controller 110 may distinguish a tap and a long tap by comparing a preset reference time and a touching time (a gap between a moment of touching the screen and a moment of the touch being separated from the screen).

The foregoing user touch including a drag, a flick, a drag and drop, a tap and a long tap is also applied to a portable device 300, which will be described. A touchscreen controller 395 (FIG. 7) of the portable device 300 may detect a user touch on a touchscreen of a second display 390, identify a type of a detected touch input, derive coordinate information on a touched position and forward the derived coordinate information to a second image processor 340 according to control of a second controller 310.

The first controller 110 displays the collaborative screen including a plurality of operation areas on the display 130, that is, the touchscreen, allocates at least one of the operation areas to a portable device of the user, for example, a portable device 302 of a student or students in a group participating in the cooperative learning, and displays the collaborative screen so that the allocated operation area is identified. The first controller 110 may control the communication device 140 to give a command to display the allocated operation area on the corresponding portable device 302.

Here, one operation area may be allocated to one portable device or may be allocated to a plurality of portable devices. When one operation area is allocated to a plurality of portable devices, a plurality of users corresponding to the portable devices may be included in a single group.

The first controller 110 may conduct first allocation of operation areas to each group including a plurality of students, and subdivide the operation areas allocated to the particular group to conduct second allocation of the operation areas to portable devices of students in the group.

Accordingly, the allocated operation areas are displayed on the portable devices 302 of the corresponding users, for example, a student or a group of a plurality of students participating in the cooperative learning. When the first and the second allocations are completed, a first allocated operation area or a second allocated operation area resulting from subdivision of the first allocated operation area may be selectively displayed on the portable device 302 of the user included in the first allocated group. The first controller 110 stores collaborative screen information including information on the allocated operation area in the first storage 160 or the server 200. To store the collaborative screen information in the server 200, the first controller 110 transmits the information to the server 200 through the communication device 140. The user, that is, a student or a teacher, may conduct an operation on the collaborative screen using the portable device thereof (the student portable device 302 or the teacher portable device 301), and the information on the conducted operation is transmitted to the display apparatus 100 or the server 200 to update the collaborative screen information previously stored in the first storage 160 or the server 200.

The first controller 110 detects a user touch on the first display 130, that is, the touchscreen, on which the collaborative screen is displayed, and controls the collaborative screen corresponding to the detected touch. For example, when the user touch is a zoom in/out manipulation using a multi-touch, the first controller 110 may control the first display to enlarge or reduce the collaborative screen corresponding to the manipulation. Here, the zoom in/out manipulation is also referred to as a pinch zoom in/out. Further, when the user touch is a flick or a drag, the first controller 110 may control the first display 130 to move and display the collaborative screen corresponding to a moving direction of the user touch. Additional exemplary embodiments of detecting the user touch and controlling the touchscreen will be described in detail with reference to the following drawings.

The display apparatus 100 may be configured to derive coordinate information on a location on the display panel 135 touched by the input device 150 among the display panels 131 to 139 and to wirelessly transmit the derived coordinate information to the image processor 120 through the communication device 140. Here, the image processor 120 displays an image on the display panel 135 touched by the input device 150 among the display panels 131 to 139.

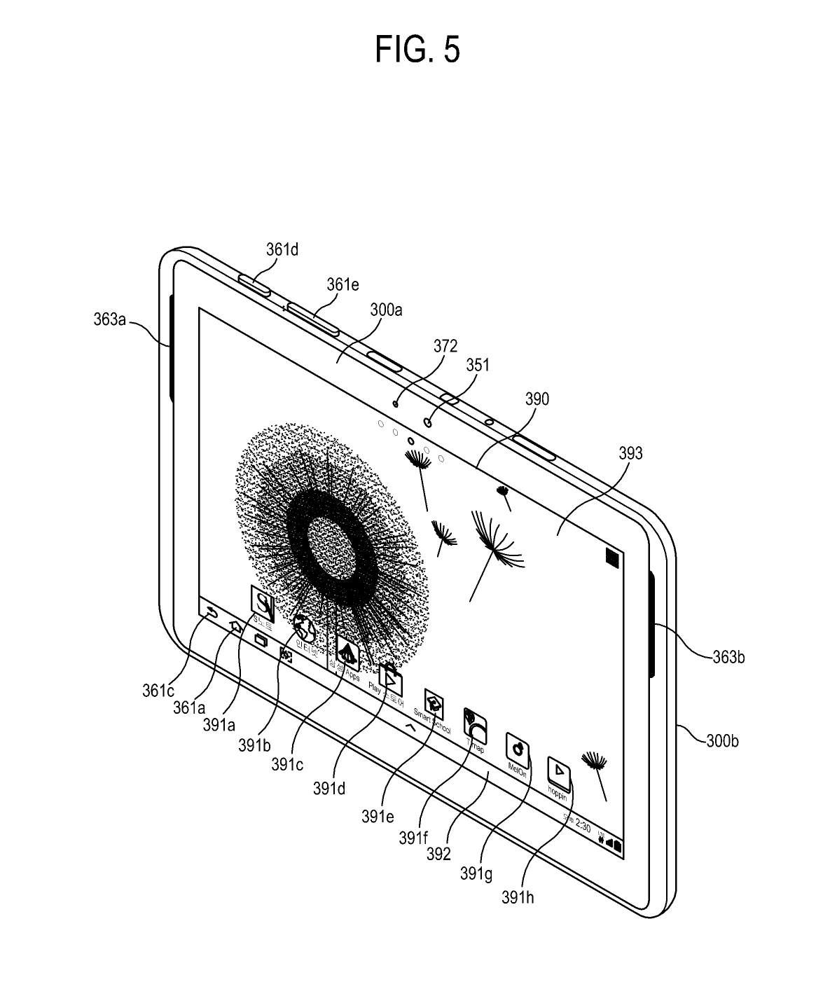

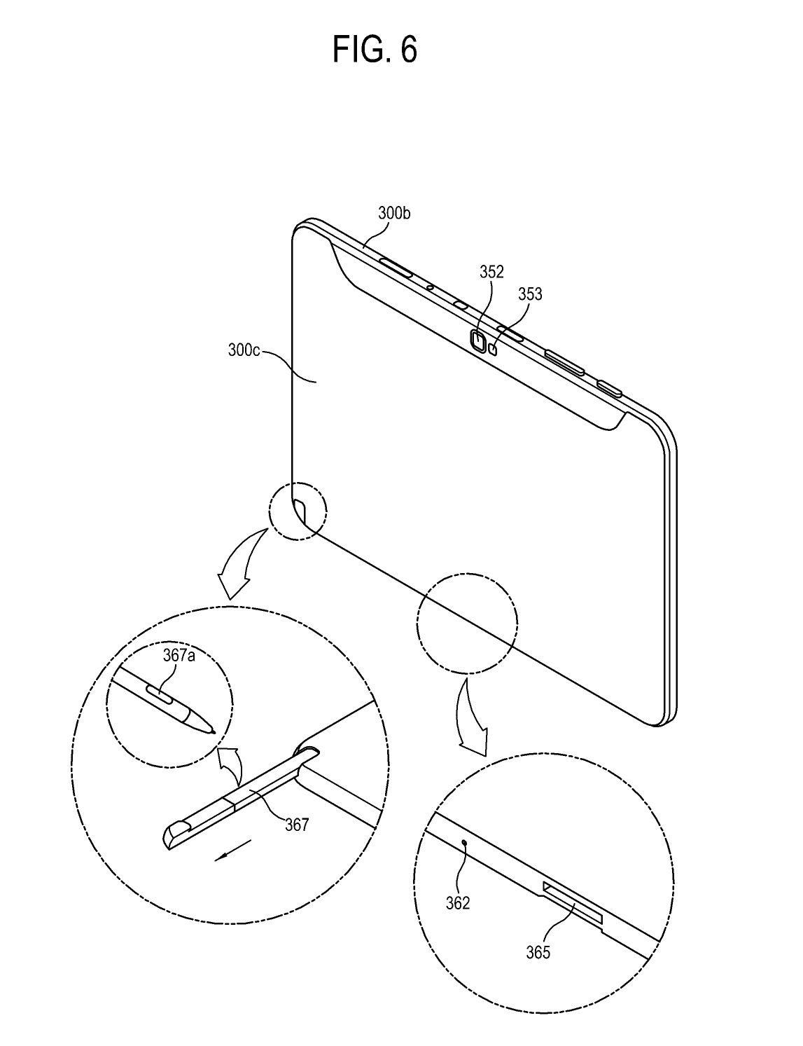

FIG. 5 is a front perspective view schematically illustrating the portable device according to an exemplary embodiment, FIG. 6 is a rear perspective view schematically illustrating the portable device 300, and FIG. 7 is a block diagram illustrating a configuration of the portable device 300 shown in FIGS. 5 and 6. The configuration of the portable device illustrated in FIGS. 5 to 7 is commonly applied to both a teacher portable device 301 and a student portable device 302.

As shown in FIGS. 5 and 6, the second display 390 is disposed in a central area of a front side 300a of the portable device 300 and includes the touchscreen 391. FIG. 5 shows that a home screen 393 is displayed on the touchscreen 391 when the user logs in to the portable device 300. The portable device 300 may have a plurality of different home screens. Shortcut icons 391a to 391h corresponding to applications selectable via a touch, a weather widget (not shown) and a clock widget (not shown) may be displayed on the home screen 391.

An application refers to software implemented on a computer version of an operating system (OS) or a mobile version of an OS and used by the user. For example, the application includes a word processor, a spreadsheet, a social networking system (SNS), a chatting application, a map application, a music player and a video player.

A widget is a small application as a GUI to ease interactions between the user and applications or the OS. Examples of the widget include a weather widget, a calculator widget and a clock widget. The widget may be installed in a form of a shortcut icon on a desktop or a portable device as a blog, a web café or a personal homepage and enables direct use of a service through a click not via a web browser. Also, the widget may include a shortcut to a specified path or a shortcut icon for running a specified application.

The application and the widget may be installed not only on the portable device 300 but on the display apparatus 100. In the present exemplary embodiment, when the user may select and execute an application, for example, an education application, installed on the portable device 300 or the display apparatus 100, a collaborative screen for cooperative learning may be displayed on the first display 130 or the second display 390.

A status bar 392 indicating a status of the portable device 300, such as a charging status of a battery, a received signal strength indicator (RSSI) and a current time, may be displayed at a bottom of the home screen 393. Further, the portable device 300 may dispose the home screen 393 above the status bar 392 or not display the status bar 392.

A first camera 351, a plurality of speakers 363a and 363b, a proximity sensor and a luminance sensor 372 may be disposed at an upper part of the front side 300a of the portable device 300. A second camera 352 and an optional flash 353 may be disposed on a rear side 300c of the portable device 300.

A home button 361a, a menu button (not shown) and a back button 361c are disposed at the bottom of the home screen 393 on the touchscreen 391 on the front side 300a of the portable device 300. A button 361 may be provided as a touch-based button instead of a physical button. Also, the button 361 may be displayed along with a text or other icons within the touchscreen 391.

A power/lock button 361d, a volume button 361e and at least one microphone may be disposed on an upper lateral side 300b of the portable device 300. A connector provided on a lower lateral side of the portable device 300 may be connected to an external device via a cable. In addition, an opening into which an input device 367 having a button 367a is inserted may be formed on the lower lateral side of the portable device 300. The input device 367 may be kept in the portable device 300 through the opening and be taken out from the portable device 300 for use. The portable device 300 may receive a user touch input on the touchscreen 391 using the input device 367, and the input device 367 is included in an input/output device 360 of FIG. 7. In the present exemplary embodiment, an input device is defined as including the button 361, a keypad 366 and the input device 367 and transmits various preset control commands or information to the second controller 310 based on a user input including a touch input.

Referring to FIGS. 5 to 7, the portable device 300 may be connected to an external device via a cable or wirelessly using a mobile communication device 320, a sub-communication device 330 and the connector 365. The external device may include other portable devices 301 and 302, a mobile phone, a smartphone, a tablet PC, an IWB and the administration server 200. The portable device 300 refers to an apparatus including the touchscreen 391 and conducting transmission and reception of data through the communication device 330 and may include at least one touchscreen. For example, the portable device 300 may include an MP3 player, a video player, a tablet PC, a three-dimensional (3D) TV, a smart TV, an LED TV and an LCD TV. Moreover, the portable device may include any apparatus which conducts data transmission and reception using an interaction, for example, a touch or a touching gesture, input on touchscreens of a connectable external device and the portable device.

As shown in FIG. 7, the portable device 300 includes the touchscreen 391 as the second display 390 and the touchscreen controller 395. The portable device 300 includes the second controller 310, the mobile communication device 320, the sub-communication device 330, the second image processor 340, a camera 350, a Global Positioning System (GPS) 355, the input/output device 360, a sensor 370, a second storage 375 and a power supply 380.

The sub-communication device 330 includes at least one of a wireless local area network (LAN) device 331 and a short-range communication device 332, and the second image processor 340 includes at least one of a broadcast communication device 341, an audio playback device 342 and a video playback device 343. The camera 350 includes at least one of the first camera 351 and a second camera 352, the input/output device 360 includes at least one of the button 361, the microphone 362, a speaker 363, a vibrating motor 364, the connector 365, the keypad 366 and the input device 367, and the sensor 370 includes the proximity sensor 371, the luminance sensor 372 and a gyro sensor 373.

The second controller 310 may include an application processor 311, a read only memory (ROM) to store a control program for controlling the portable device 300 and a random access memory 313 to store a signal or data input from an outside of the portable device 300 or to store various operations implemented on the portable device 300.

The second controller 310 controls general operations of the portable device and flow of signals between internal elements 320 to 395 of the portable device 300 and functions to process data. The second controller 310 controls supply of power from the power supply 380 to the internal elements 320 to 395. Further, when a user input is made or a stored preset condition is satisfied, the second controller 310 may conduct an OS or various applications stored in the second storage 375.

In the present exemplary embodiment, the second controller 310 includes the AP 311, the ROM 312 and the RAM 313. The AP 311 may include a graphic processor (not shown) to conduct graphic processing. The AP 311 may be provided as a system on chip (SOC) of a core (not shown) and the GPU. The AP 311 may include a single core, a dual core, a triple core, a quad core and multiple cores thereof. Further, the AP 311, the ROM 312 and the RAM 313 may be connected to each other via an internal bus.

The second controller 310 may control the mobile communication device 320, the sub-communication device 330, the second image processor 340, the camera 350, the GPS device 355, the input/output device 360, the sensor 370, the second storage 375, the power supply 380, the touchscreen 391 and the touchscreen controller 395.

The mobile communication device 320 may be connected to an external device using mobile communications through at least one antenna (not shown) according to control by the second controller 310. The mobile communication device 320 conducts transmission/reception of wireless signals for a voice call, a video call, a short message service (SMS), a multimedia message service (MMS) and data communications with a mobile phone, a smartphone, a tablet PC or other portable devices having a telephone number connectable to the portable device 300.

The sub-communication device 330 may include at least one of the wireless LAN device 331 and the short-range communication device 332. For example, the sub-communication device 330 may include the wireless LAN device 331 only, include the short-range communication device 332 only, or include both the wireless LAN device 331 and the short-range communication device 332.

The wireless LAN device 331 may be wirelessly connected to an access point according to control by the second controller 310 in a place where the access point is installed. The wireless LAN device 332 supports an Institute of Electrical and Electronics Engineers (IEEE) standard, IEEE 802.11x. The short-range communication device 332 may implement wireless short-range communications between the portable device 300 and an external device according to control by the second controller 310 without any access point. The short-range communications may be conducted using Bluetooth, Bluetooth low energy, infrared data association (IrDA), Wi-Fi, Ultra Wideband (UWB) and Near Field Communication (NFC).

The portable device 300 may include at least one of the mobile communication device 320, the wireless LAN device 331 and the short-range communication device 332 based on a performance thereof. For example, the portable device 300 may include a combination of the mobile communication device 320, the wireless LAN device and the short-range communication device 332 based on performance thereof.

In the present exemplary embodiment, the sub-communication device 330 may be connected to another portable device, for example, the teacher portable device 301 and the student portable device 302, or to the IWB 100 according to control by the second controller 310. The sub-communication device 330 may transmit and receive the collaborative screen information including a plurality of operation areas according to control by the second controller 310. The sub-communication device 330 may conduct transmission and reception of control signals with another portable device, for example, the teacher portable device 301 and the student portable device 302, or with the IWB 100 according to control by the second controller 310. In the present exemplary embodiment, the collaborative screen may be shared by the transmission and reception of data.

The second image processor 340 may include the broadcast communication device 341, the audio playback device 342 or the video playback device 343. The broadcast communication device 341 may receive a broadcast signal, for example, a TV broadcast signal, a radio broadcast signal or a data broadcast signal, and additional broadcast information, for example, an electronic program guide (EPG) or an electronic service guide (ESG), transmitted from an external broadcasting station through a broadcast communication antenna (not shown) according to control by the second controller 310. The second controller may process the received broadcast signal and the additional broadcast information using a video codec device and an audio codec device to be played back by the second display 390 and the speakers 363a and 363b.

The audio playback device 342 may process an audio source, for example, an audio file with a filename extension of .mp3, .wma, .ogg or .wav, previously stored in the second storage 375 of the portable device 300 or externally received to be played back by the speakers 363a and 363b according to control by the second controller 310.

In the present exemplary embodiment, the audio playback device 342 may also play back an auditory feedback, for example, an output audio source stored in the second storage 375, corresponding to a touch or consecutive movements of a touch detected on the touchscreen 391 through the audio codec device according to control by the second controller 310.

The video playback device 343 may play back a digital video source, for example, a file with a filename extension of .mpeg, .mpg, .mp4, .avi, .mov or .mkv, previously stored in the second storage 375 of the portable device 300 or externally received using the video codec device according to control by the second controller 310. Most applications installable in the portable device 300 may play back an audio source or a video file using the audio codec device or the video codec device.

In the present exemplary embodiment, the video playback device 343 may play back a visual feedback, for example, an output video source stored in the second storage 375, corresponding to a touch or consecutive movements of a touch detected on the touchscreen 391 through the video codec device according to control by the second controller 310.

It should be understood by a person skilled in the art that different types of video and audio codec devices may be used in the exemplary embodiments.

The second image processor 340 may include the audio playback device 342 and the video playback device 343, excluding the broadcast communication device 341, in accordance with the performance or structure of the portable device 300. Also, the audio playback device 342 or the video playback device 343 of the second image processor 340 may be included in the second controller 310. In the present exemplary embodiment, the term “video codec device” may include at least one video codec device. Also, the term “audio codec device” may include at least one audio codec device.

The camera 350 may include at least one of the first camera 351 on the front side 300a and the second camera 352 on the rear side 300c to take a still image or a video according to control by the second controller 310. The camera 350 may include one or both of the first camera 351 and the second camera 352. The first camera 351 or the second camera 352 may include an auxiliary light source, for example, the flash 353, to provide a needed amount of light for taking an image.

When the first camera 351 on the front side 300a is adjacent to an additional camera disposed on the front side, for example, a third camera (not shown), for instance, when a distance between the first camera 351 on the front side 300a and the additional camera is greater than 2 cm and shorter than 8 cm, the first camera 351 and the additional camera may take a 3D still image or a 3D video. Also, when the second camera 352 on the rear side 300c is adjacent to an additional camera disposed on the front side, for example, a fourth camera (not shown), for instance, when a distance between the second camera 352 on the rear side 300c and the additional camera is greater than 2 cm and shorter than 8 cm, the second camera 352 and the additional camera may take a 3D still image or a 3D video. In addition, the second camera 352 may take wide-angle, telephotographic or close-up picture using a separate adaptor (not shown).

The GPS device 355 periodically receives information, for example, accurate location information and time information on a GPS satellite (not shown) received by the portable device 300, from a plurality of GPS satellites (not shown) orbiting around the earth. The portable device 300 may identify a location, speed or time of the portable device 300 using the information received from the GPS satellites.

The input/output device 360 may include at least one of the button 361, the microphone 362, the speaker 363, the vibrating motor 364, the connector 365, the keypad 366 and the input device 367.

Referring to the portable device 300 shown in FIGS. 5 to 7, the button 361 includes the menu button 361b, the home button 361a and the back button 361c on the bottom of the front side 300a of the portable device. The button 361 may include the power/lock button 361d and at least one volume button 361e on the lateral side 300b of the portable device. In the portable device 300, the button 361 may include the home button 361a only. The button 361 may be provided as a touch-based button on an outside of the touchscreen 391 instead of physical buttons. Also, the button 361 may be displayed as a text or an icon within the touchscreen 391.

The microphone 362 externally receives an input of a voice or a sound to generate an electric signal according to control by the second controller 310. The electric signal generated in the microphone 362 is converted in the audio codec device and stored in the second storage 375 or output through the speaker 363. The microphone 362 may be disposed on at least one of the front side 300a, the lateral side 300b and the rear side 300c of the portable device 300. Alternatively, at least one microphone 362 may be disposed only on the lateral side 300b of the portable device 300.

The speaker 363 may output sounds corresponding to various signals, for example, wireless signals, broadcast signals, audio sources, video files or taken pictures, from the mobile communication device 320, the sub-communication device 330, the second image processor 340 or the camera 350 out of the portable device 300 using the audio codec device according to control by the second controller 310.

The speaker 363 may output a sound corresponding to a function performed by the portable device, for example, a touch sound corresponding to input of a telephone number and a sound made when pressing a photo taking button. At least one speaker 363 may be disposed on the front side 300a, the lateral side 300b or the rear side 300c of the portable device 300. In the portable device 300 shown in FIGS. 5 to 7, the plurality of speakers 363a and 363b are disposed on the front side 300a of the portable device 300. Alternatively, the speakers 363a and 363b may be disposed on the front side 300a and the rear side 300c of the portable device 300, respectively. Also, one speaker 363a may be disposed on the front side 300a of the portable device 300 and a plurality of speakers 363b (one of which is not shown) may be disposed on the rear side 300c of the portable apparatus.

In addition, at least one speaker (not shown) may be disposed on the lateral side 300b. The portable device 300 having the at least one speaker disposed on the lateral side 300b may provide the user with different sound output effects from a portable device (not shown) having speakers disposed on the front side 300a and the rear side 300c only without any speaker on the lateral side 300b.

In the present exemplary embodiment, the speaker 363 may output the auditory feedback corresponding to a touch or consecutive movements of a touch detected on the touchscreen 391 according to control by the second controller 310.

The vibrating motor 364 may convert an electric signal to mechanical vibrations according to control by the second controller 310. For example, the vibrating motor 364 may include a linear vibrating motor, a bar-type vibrating motor, a coin-type vibrating motor or a piezoelectric vibrating motor. When a voice call request is received from another portable device, the vibrating motor 364 of the portable device 300 in vibration mode operates according to control by the second controller 310. At least one vibrating motor 364 may be provided for the portable device. 300. Also, the vibrating motor 364 may vibrate the entire portable device 300 or only part of the portable device 300.

The connector 365 may be used as an interface to connect the portable device to an external device (not shown) or a power source (not shown). The portable device may transmit data stored in the second storage 375 to the external device or receive data from the external device through a cable connected to the connector 365 according to control by the second controller 310. The portable device 300 may be supplied with power from the power source, or a battery (not shown) of the portable device 300 may be charged through the cable connected to the connector 365. In addition, the portable device 300 may be connected to an external accessory, for example, a keyboard dock (not shown), through the connector 365.

The keypad 366 may receive a key input from the user so as to control the portable device 300. The keypad 366 includes a physical keypad (not shown) formed on the front side 300a of the portable device 300, a virtual keypad (not shown) displayed within the touchscreen 391 and a physical keypad (not shown) connected wirelessly. It should be readily noted by a person skilled in the art that the physical keypad formed on the front side 300a of the portable device 300 may be excluded based on the performance or structure of the portable device 300.

The input device 367 may touch or select an object, for example, a menu, a text, an image, a video, a figure, an icon and a shortcut icon, displayed on the touchscreen of the portable device 300. The input device 367 may touch or select content, for example, a text file, an image file, an audio file, a video file or a reduced student personal screen, displayed on the touchscreen 391 of the portable device 300. The input device 367 may input a text, for instance, by touching a capacitive touchscreen, a resistive touchscreen and an electromagnetic induction touchscreen or using a virtual keyboard. The input device may include a pointing device, a stylus and a haptic pen with an embedded pen vibrating element, for example, a vibration motor or an actuator, vibrating using control information received from the communication device 330 of the portable device 300. The vibrating element may also vibrate using sensing information detected by a sensor (not shown) embedded in the input device 367, for instance, an acceleration sensor, instead of the control information received from the portable device 300. It should be readily noted by a person skilled in the art that the input device 367 to be inserted into the opening of the portable device 300 may be excluded based on the performance or structure of the portable device 300.

The sensor 370 includes at least one sensor to detect a status of the portable device 300. For example, the sensor 370 may include the proximity sensor 371 disposed on the front side 300a of the portable device 300 and detecting approach to the portable device 300, the luminance sensor 372 to detect an amount of light around the portable device 300, the gyro sensor 373 to detect a direction using rotational inertia of the portable device 300, an acceleration sensor (not shown) to detect a slope on three x, y and z axes to the portable device 300, a gravity sensor to detect a direction in which gravity is exerted or an altimeter to detect an altitude by measuring atmospheric pressure.

The sensor 370 may measure an acceleration resulting from addition of an acceleration of the portable device 300 in motion and acceleration of gravity. When the portable device 300 is not in motion, the sensor 370 may measure the acceleration of gravity only. For example, when the front side of the portable device 300 faces upwards, the acceleration of gravity may be in a positive direction. When the rear side of the portable device 300 faces upwards, the acceleration of gravity may be in a negative direction.

At least one sensor included in the sensor 370 detects the status of the portable device 300, generates a signal corresponding to the detection and transmits the signal to the second controller 310. It should be readily noted by a person skilled in the art that the sensors of the sensor 370 may be added or excluded based on the performance of the portable device 300.

The second storage 375 may store signals or data input and output corresponding to operations of the mobile communication device 320, the sub-communication device 330, the second image processor 340, the camera 350, the GPS device 355, the input/output device 360, the sensor 370 and the touchscreen 391 according to control by the second controller 310. The second storage 375 may store a GUI associated with a control program for controlling the portable device 300 or the second controller 310, and applications provided by a manufacturer or downloaded externally, images for providing the GUI, user information, a document, databases or relevant data.

In the present exemplary embodiment, the second storage 375 may store the collaborative screen received from the first storage 160 of the IWB 100 or the server 200. When an application for cooperative learning, for instance, an educational application, is implemented on the portable device 300, the second controller 310 controls the sub-communication device 330 to access the first storage 160 or the server 200, receives information including the collaborative screen from the first storage 160 or the server, and stores the information in the second storage 375. The collaborative screen stored in the second storage 375 may be updated according to control by the second controller 310, and the updated collaborative screen may be transmitted to the first storage 160 or the server 200 through the sub-communication device 330 to be shared with the IWB 100 or other portable devices 301 and 302.

The second storage 375 may store touch information corresponding to a touch and/or consecutive movements of a touch, for example, x and y coordinates of a touched position and time at which the touch is detected, or hovering information corresponding to a hovering, for example, x, y and z coordinates of the hovering and hovering time. The second storage 375 may store a type of the consecutive movements of the touch, for example, a flick, a drag, or a drag and drop, and the second controller 310 compares an input user touch with the information in the second storage 375 to identify a type of the touch. The second storage may further store a visual feedback, for example, a video source, output to the touchscreen 391 to be perceived by the user, an auditory feedback, for example, a sound source, output from the speaker 363 to be perceived by the user, and a haptic feedback, for example, a haptic pattern, output from the vibrating motor 364 to be perceived by the user, the feedbacks corresponding to an input touch or touch gesture.

In the present exemplary embodiment, the term “second storage” includes the second storage 375, the ROM 312 and the RAM 313 in the second controller 310, and a memory card (not shown), for example, a micro secure digital (SD) card and a memory stick, mounted on the portable device 300. The second storage may include a nonvolatile memory, a volatile memory, a hard disk drive (HDD) or a solid state drive (SSD).

The power source 380 may supply power to at least one battery (not shown) disposed in the portable device 300 according to control by the second controller 310. The at least one battery is disposed between the touchscreen 391 on the front side 300a and the rear side 300c of the portable device 300. The power supply 380 may supply power input from an external power source (not shown) through a cable (not shown) connected to the connector to the portable device 300 according to control by the second controller 310.

The touchscreen 391 may provide the user with GUIs corresponding to various services, for example, telephone calls, data transmission, a broadcast, taking pictures, a video or an application. The touchscreen 391 transmits an analog signal corresponding to a single touch or a multi-touch input through the GUIs to the touchscreen controller 395. The touchscreen 391 may receive a single-touch or a multi-touch input made by a user's body part, for example, a finger including a thumb, or made by touching the input device 367.

In the present exemplary embodiment, the touch may include not only contact between the touchscreen 391 and a user's body part or the touch-based input device 367 but noncontact therebetween, for example, a state of the user's body part or the input device 367 hovering over the touchscreen 391 at a detectable distance of 30 mm or shorter. It should be understood by a person skilled in the art that the detectable noncontact distance from the touchscreen 391 may be changed based on the performance or the structure of the portable device 300.

The touchscreen 391 may include, for instance, a resistive touchscreen, a capacitive touchscreen, an infrared touchscreen and an acoustic wave touchscreen.

The touchscreen controller 395 converts the analog signal corresponding to the single touch or the multi-touch received from the touchscreen 391 into a digital signal, for example, x and y coordinates of a detected touched position, and transmits the digital signal to the second controller 310. The second controller 310 may derive the x and y coordinates of the touched position on the touchscreen 391 using the digital signal received from the touchscreen controller 395. In addition, the second controller 310 may control the touchscreen 391 using the digital signal received from the touchscreen controller 395. For example, the second controller 310 may display a selected shortcut icon 391e to be distinguished from other shortcut icons 391a to 391d on the touchscreen 391 or implement and display an application, for example, an education application, corresponding to the selected shortcut icon 391e on the touchscreen 391 in response to the input touch.

In the present exemplary embodiment, one or more touchscreen controllers may control one or more touchscreens 391. The touchscreen controller 395 may be included in the second controller 310 depending on the performance or structure of the portable device 300.

The second controller 310 displays the collaborative screen including the plurality of operation areas on the display 390, that is, the touchscreen 391, allocates at least one of the operation areas to the user, for example, a student or a group participating in the cooperative learning, and displays the collaborative screen with the allocated operation area being distinguishable. Here, the allocated operation area is displayed on the portable device of the user, the student or the group participating in the cooperative learning.

The second controller 310 stores collaborative screen information including information on the allocated operation area in the first storage 160 of the display apparatus or the server 200. To this end, the second controller 310 transmits the collaborative screen information to the display apparatus 100 or the server 200 through the sub-communication device 330. The user, that is, the student or teacher, may perform an operation on the collaborative screen using the own portable device (the student portable device 302 or the teacher portable device 301), and information on the performed operation may be transmitted to the display apparatus 100 or the server 200, thereby updating the collaborative screen information previously stored in the first storage 150 or the server 200.

The second controller 310 detects a user touch on the second display 330, that is, the touchscreen 391, on which the collaborative screen is displayed and controls the collaborative screen corresponding to the detected touch. For example, when the user touch is a zoom in/out manipulation using a multi-touch, the second controller 310 may control the second display 330 to enlarge or reduce the collaborative screen corresponding to the manipulation. Here, the zoom in/out manipulation is also referred to as a pinch zoom in/out. Further, when the user touch is a flick or a drag, the second controller 310 may control the second display 330 to move and display the collaborative screen corresponding to a moving direction of the user touch. Additional exemplary embodiments of detecting the user touch and controlling the touchscreen will be described in detail with reference to the following drawings.

At least one component may be added to the components of the portable device 300 shown in FIG. 7 or at least one of the components may be excluded from the components corresponding to the performance of the portable device 300. Further, locations of the components may be changed and modified corresponding to the performance or structure of the portable device 300.

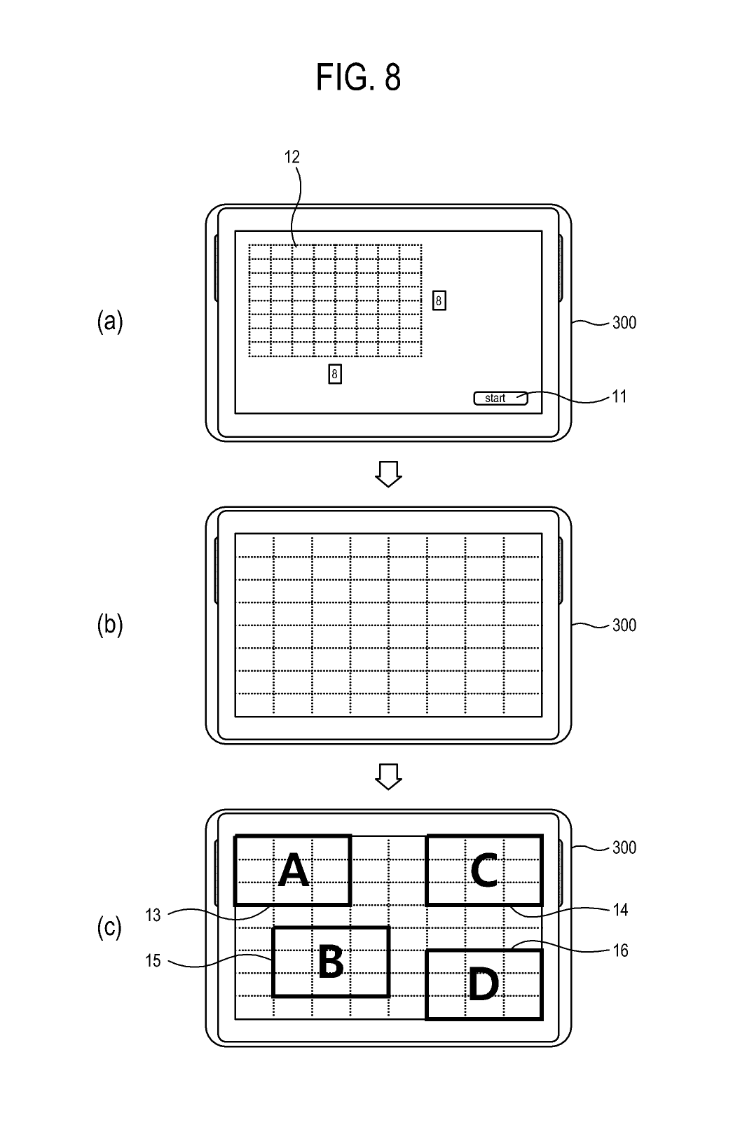

Hereinafter, screen control processes based on a user manipulation performed by the display apparatus 100 or the portable device 300 according to exemplary embodiments will be described in detail with reference to FIGS. 8 to 23.

FIGS. 8 to 10 illustrate a process of generating a collaborative screen and allocating an operation area according to an exemplary embodiment.

Referring to FIGS. 8 to 10, a user, for example, a teacher, generates a collaborative screen (hereinafter, also referred to as a collaborative panel) for cooperative learning in a board form on a teacher portable device (teacher tablet) 301 or the display apparatus (IWB) 100. To this end, the user may implement an application, for example, an educational application, preinstalled on the device 100 or 301 and touch a GUI for generating the collaborative panel displayed on the touchscreen as a result of implementation of the application.

As shown in FIG. 8, the teacher selects a button 11 for generating the collaborative panel on the touchscreen 391 of the portable device 300 and specifies a matrix (row/column) size, for example, 8×8, of the collaborative panel, thereby generating a collaborative screen 12 with the specified size (a). Here, a template for setting the collaborative panel may be provided on the touchscreen 391 in accordance with selection of the collaborative panel generating button 11.

The user may tap the collaborative screen 12 to enable the collaborative screen to be displayed as a full screen FIG. 8(b), divide the collaborative screen 12 into a plurality of operation areas 13, 14, 15 and 16 and allocate the divided operation areas 13, 14, and 16 to students FIG. 8(c). The second controller 310 may detect a touch input received from the user to generate the collaborative screen 12, display the collaborative screen 12 on the touchscreen 391 and allocate at least one of the operation areas 13, 14, 15 and 16 to a relevant user based on the user input with respect to the displayed collaborative screen 12.

The operation areas 13, 14, 15 and 16 may be allocated to each group or team including one student or a plurality of students. Here, the portable device 300 may use the camera 350 to perform group allocation. For example, an identification mark of a group allocated in advance to students is photographed using the rear camera 351, and students corresponding to the identification mark are set into one group and allocated an operation area.

As shown in FIG. 8(c), the allocated operation areas 13, 14, 15 and 16 are displayed distinguishably on the full collaborative screen 12 of the first display 130.

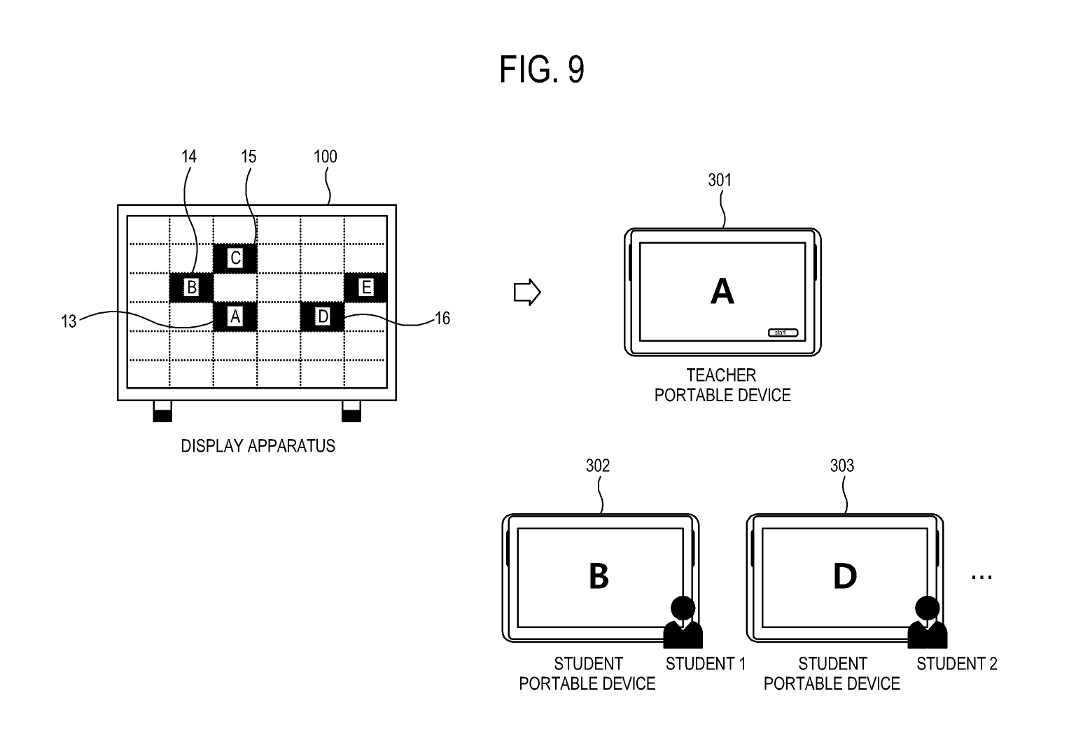

Although FIG. 8 illustrates that the portable device 300, that is, the teacher portable device 301 is used in generating the collaborative screen 12 and allocating the operation areas 13, 14, 15 and 16, the display apparatus 100, that is the IWB, may also be used in generating a collaborative screen and allocating an operation area as shown in FIG. 9.

Referring to FIG. 9, when the collaborative screen 12 includes five operation areas A, B, C, D and E, an operation area B (14) may be allocated to Student 1 and an operation area D (16) may be allocated to Student 2. Accordingly, the operation area B is displayed on a portable device 302 of Student 1 and the operation area D is displayed on a portable device 303 of Student 2. An operation area A (13) displayed on the teacher portable device 301 may be an operation area allocated to a different student or group or a presentation area for results of the cooperative learning performed by all students. The teacher may monitor works of the students on the operation areas A to E 13, 14, 15 and 16 using the teacher portable device 301.

To this end, the display apparatus 100, the server 200, the display apparatus 100, and the portable device 300 are linked.

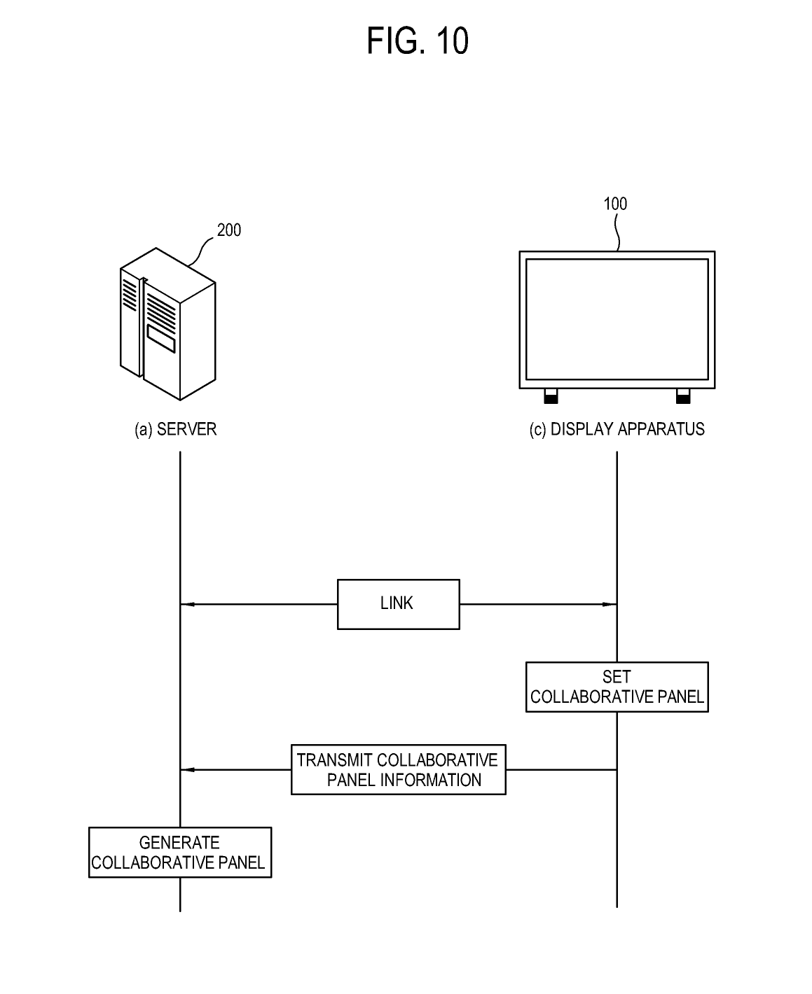

As shown in FIG. 10, when the user input for generating the collaborative screen is received through the display apparatus 100 and collaborative screen information is stored in the server 200, the display apparatus 100 and the server 200 are linked to each other by respectively having opponents' lists through a reciprocal investigation. When the display apparatus 100 receives a user input to set the size of the collaborative panel 12 and initial states of the operation areas 13, 14, 15 and 16, received setting information on the collaborative panel 12 (the size and initial states of the operations areas) and device information on the display apparatus 100 are transmitted to the server 200 through the communication device 140. The server 200 stores collaborative panel information generated based on the received information.

When the user input for generating the collaborative screen is received through the teacher portable device 301 and the collaborative screen information is stored in the first storage 160 of the display apparatus 100, the teacher portable device 301 and the display apparatus 100 are linked to each other by respectively having opponents' lists through a reciprocal investigation. When the teacher portable device 301 receives a user input to set the size of the collaborative panel 12 and initial states of the operation areas 13, 14, 15 and 16, received setting information on the collaborative panel 12 (the size and initial states of the operations areas) and device information on the teacher portable device 301 are transmitted to the display apparatus 100 through the communication device 330. The display apparatus 100 stores collaborative panel information generated based on the received information in the first storage 160.

In the same manner, the setting information on the collaborative panel of the teacher portable device 301 and the device information on the teacher portable device 301 may be transmitted to the server 200 and stored.

The user may delete the collaborative panel generated in FIGS. 8 to 10 in accordance with a user manipulation using the display apparatus 100 or the portable device 300. Deletion of the collaborative panel may include deleting the whole collaborative panel and deleting some operation areas. As the collaborative panel is deleted, the information in the first storage 160 or the server 200 may be updated accordingly.

The collaborative screen including the operation areas shown in FIG. 8C and may distinguishably display a user allocated operation area and a non-user allocated operation area. Further, the collaborative screen may distinguishably display an activated area that the use is currently working on and a deactivated area that the user is not currently working on. For example, the activated area may be displayed in color, while the deactivated area may be displayed in a grey hue. The activated area may further display identification information on the user or group of the area. The teacher may easily monitor the operation areas through the collaborative screen displayed on the display apparatus 100 or the teacher portable device 301.

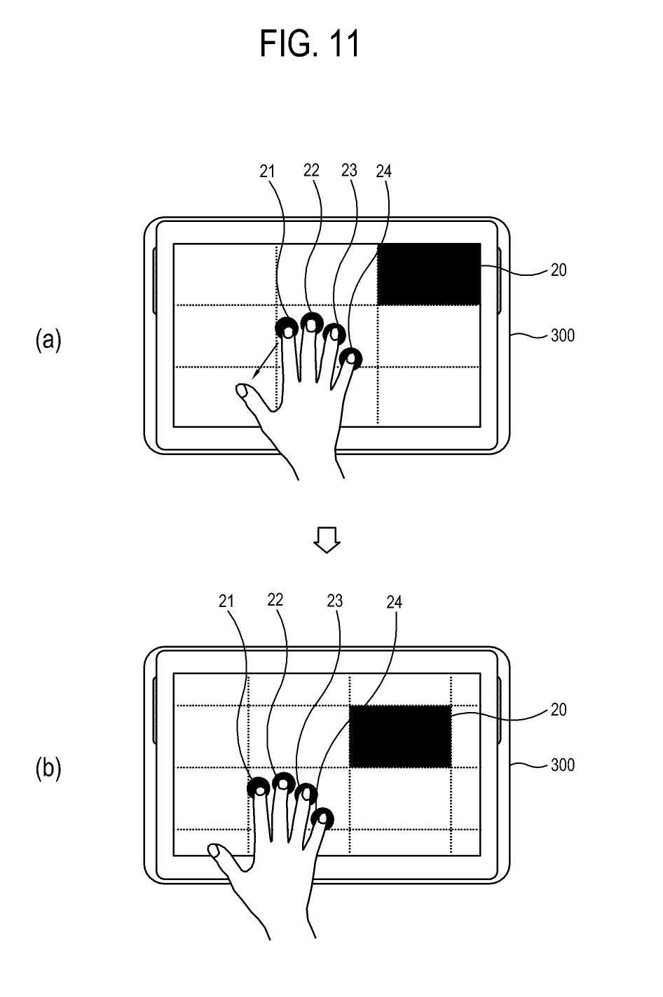

Hereinafter, a process of controlling a touchscreen based on a user touch according to an exemplary embodiment will be described with reference to FIGS. 11 to 18. FIGS. 11 to 18 illustrate a process of controlling the touchscreen 391 of the portable device based on a user touch, which may be also applied to the touchscreen of the first display of the display apparatus 100.

The user may select an operation area by touching the area on the collaborative screen displayed on the displays 130 and 390 and deselect the area by touching the area again.

FIG. 11 illustrates an example of moving the screen of the touchscreen according to the exemplary embodiment.

As shown in FIG. 11, the user may conduct a flick or drag touch operation on the touchscreen 391 to different locations within the screen while holding the touch FIG. 11(a). Here, the user may move or swipe the collaborative panel in opposite directions, for example, a bottom left direction, to a screen area 20 disposed at a top right side that the user wishes to see. The touchscreen controller 395 may detect the user touch and control the touchscreen 391 to move the collaborative screen on the display corresponding to a moving direction of the user touch FIG. 11(b).

In the present exemplary embodiment, as shown in FIG. 11, the user may receive a user manipulation of a flick or a drag while a plurality of fingers 21, 22, 23 and 24 touch the touchscreen 391 via a multi-touch operation, for example, a four-finger touch FIG. 11(a), and move the collaborative screen on the display corresponding to a moving direction of a user manipulation.

To this end, the portable device 300 communicates with the server 200 and/or the display apparatus to transmit and receive data.

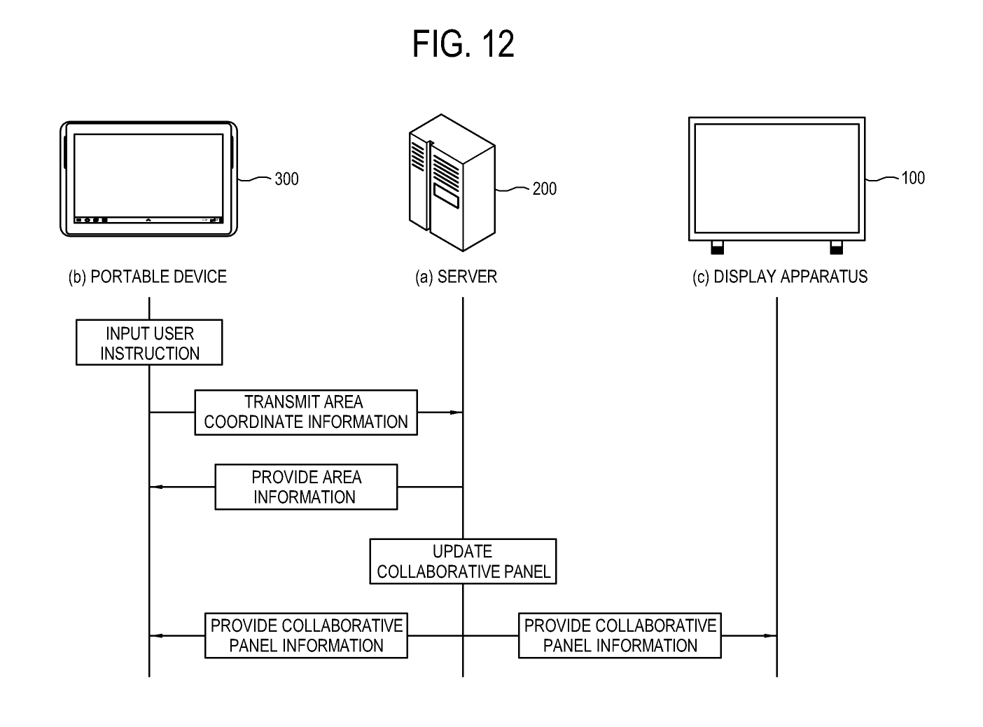

FIG. 12 schematically illustrates a process of transmitting and receiving data for controlling the touchscreen based on a user touch according to an exemplary embodiment.

As shown in FIG. 12, when a user instruction based on a user touch including, but not limited to, a drag, a flick, a zoom in/out, a drag and drop, a tap and a long tap is input through the portable device 300, coordinate information on an area corresponding to the touch is transmitted to the server 200. The coordinate information on the area may include coordinate information on an area to be displayed on the portable device 300 after the collaborative panel is moved according to the user instruction.

The server 200 provides pre-stored area information (screen and property information) corresponding to the user instruction to the portable device 300 and updates the pre-stored collaborative panel information corresponding to the received user instruction. The updated collaborative panel information is provided to the portable device 300 and the display apparatus 100. Here, the updated collaborative panel information may be provided to all devices registered for the cooperative learning, for example, the display apparatus 100, the teacher portable device 301 and the student portable devices 302.

When the collaborative panel information is stored in the first storage 160 of the display apparatus 100, the coordinate information based on the user instruction input through the portable device 300 is transmitted to the display apparatus 100, and the display apparatus 100 may update the collaborative panel information pre-stored in the first storage and provide the collaborative panel information to the portable device 300. In the same manner, information (including coordinate information) based on a user manipulation on the collaborative panel performed in the display apparatus 100 may be transmitted and updated to be provided to both the portable device 300 and the display apparatus 100.

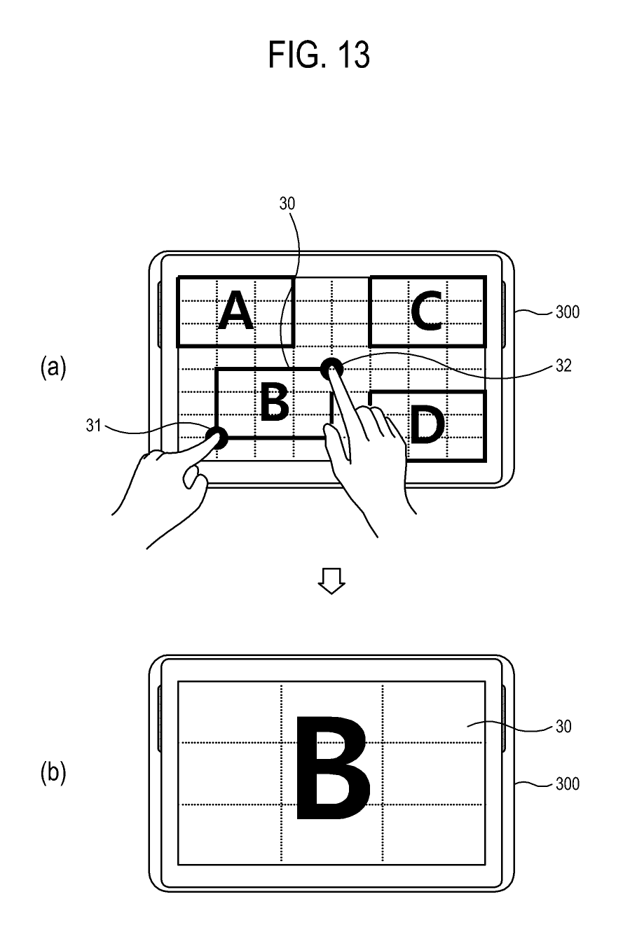

FIG. 13 illustrates an example of enlarging and reducing the screen of the touchscreen according to an exemplary embodiment.

As shown in FIG. 13, the user may conduct a zoom in (also referred to as pinch zoom in) manipulation using a multi-touch 31 and 32 on an operation area B 30, with the collaborative screen including a plurality of operation areas A, B, C and D being viewed on the touchscreen 391 FIG. 13(a). The touchscreen controller 395 may detect the user touch and control the touchscreen 391 to enlarge or reduce the screen corresponding to the zoom in manipulation on the display FIG. 13(b). In the same manner, the user conducts a zoom out manipulation using a multi-touch to reduce the screen of the touchscreen.

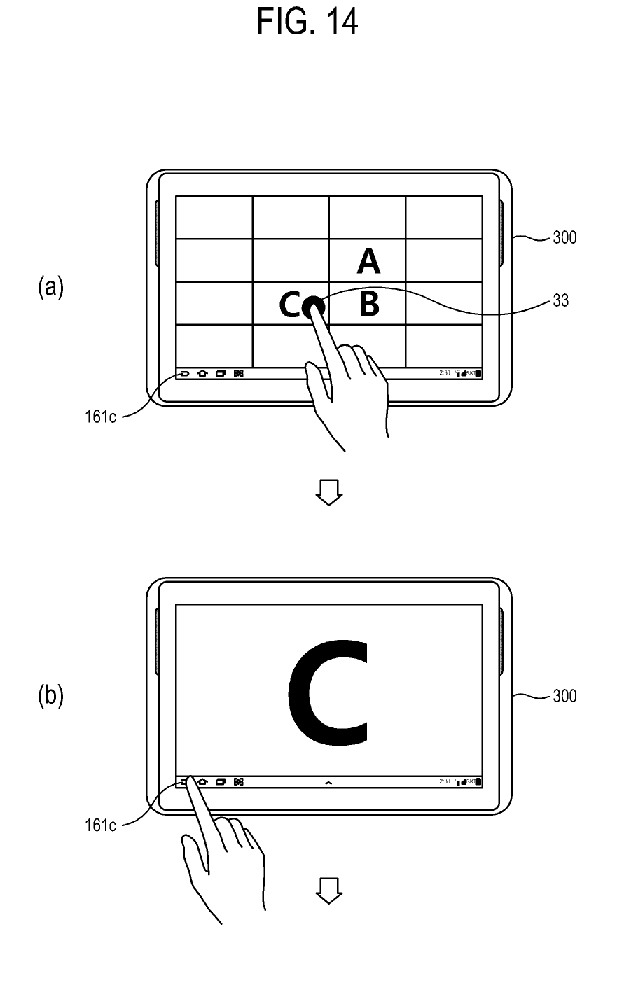

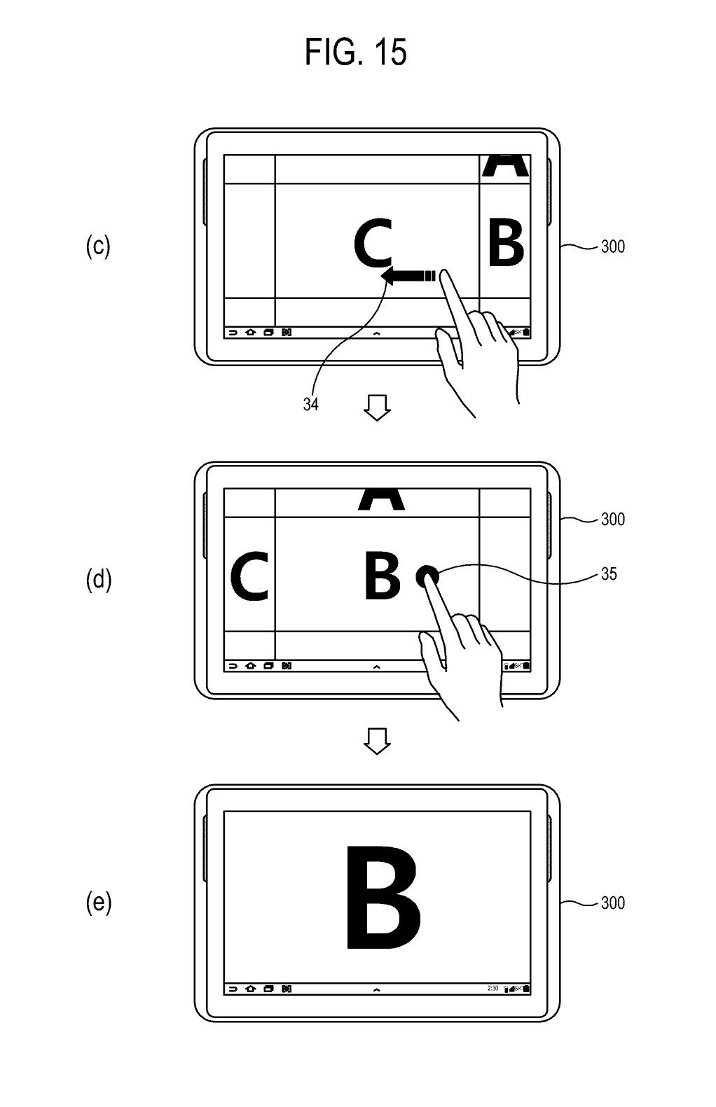

FIGS. 14 and 15 illustrate an example of reducing and moving the screen using a back button according to an exemplary embodiment.

As shown in FIG. 14, when the user conducts a tap operation 33 on an operation area C FIG. 14(a) with the collaborative screen including a plurality of operation areas A, B and C being viewed on the touchscreen 391, the operation area C may be displayed as the full screen of the touchscreen 391 FIG. 14(b). When the user selects or clicks a back button 361c among menu items 361a and 361c disposed at one region of the screen, for example, a bottom region of the screen, the screen is reduced such that part of operation areas including A and B adjacent to the operation area C displayed as the full screen is displayed on the screen of the touchscreen 391 FIG. 15(c). While the reduced screen is being displayed as shown in FIG. 15(c), the user may move the screen through a user manipulation including a drag or flick FIG. 15(d). While the screen moved corresponding to a moving direction of the user touch is being displayed, when the user conducts a tap operation 35 on another operation area B, the operation area B may be displayed as a full screen of the touchscreen 391 (e).

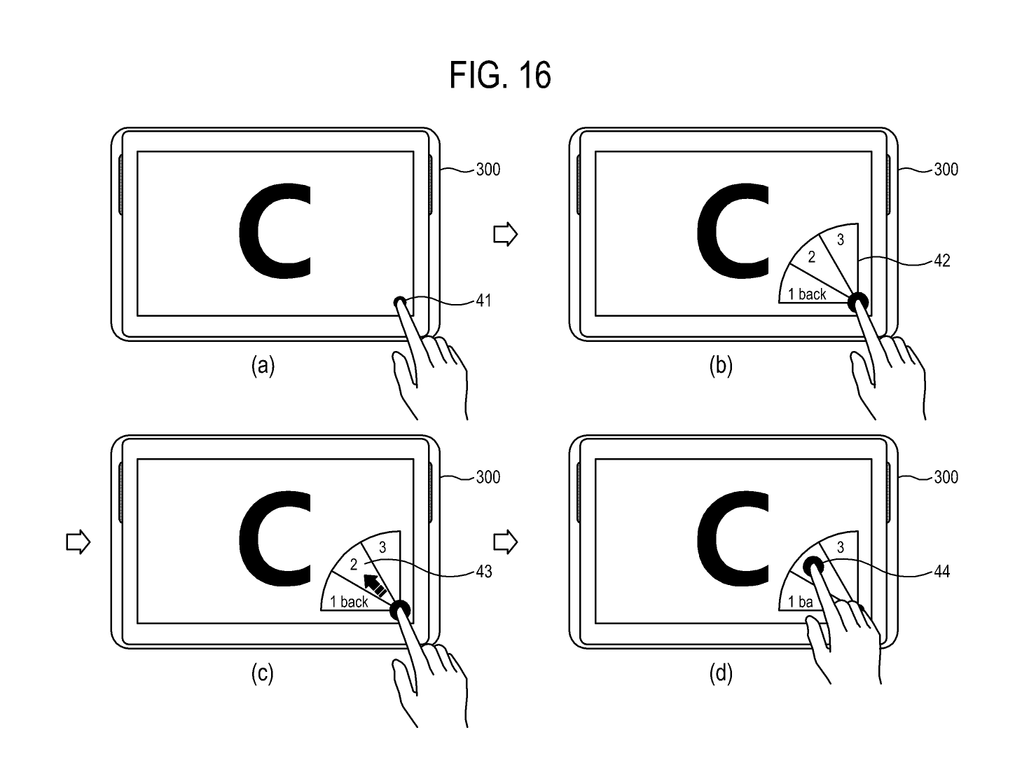

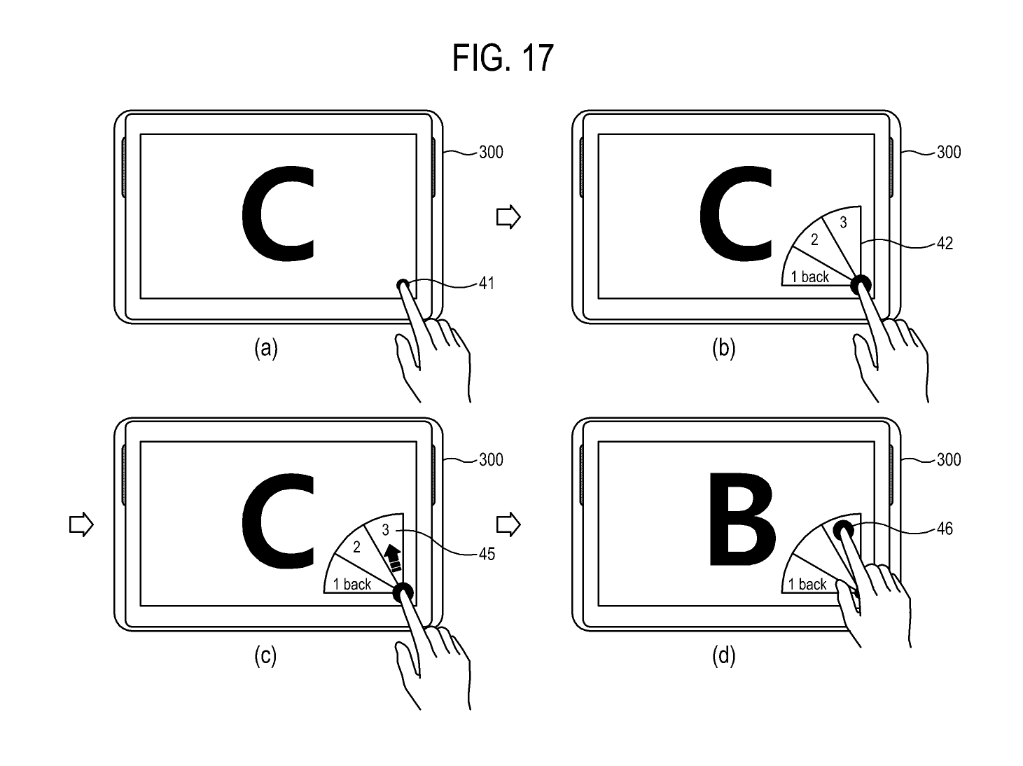

FIGS. 16 and 17 illustrate an example of registering an operation area as a bookmark and moving or jumping to an operation area in a previously registered bookmark, with an operation area being displayed as a full screen on the touchscreen as in FIGS. 14 and 15.

As shown in FIG. 16, with an operation area C being displayed as a full screen on the touchscreen 391, the user may perform a long selection, for example, a long tap, on a circular menu icon (also referred to as a center ball) 41 disposed at one region of the screen FIG. 16(a). A plurality of bookmark items 42 is displayed on the screen of the touchscreen corresponding to the input long tap FIG. 16(b). A bookmark 1 among the bookmark items 42 may correspond to an operation area, for example, A, which was recently manipulated.

The user may conduct a drag operation from the menu icon 41 to one bookmark 43, for example, a bookmark 2, among the bookmark items 42 FIG. 16(c) and conduct a long tap 44 on the bookmark 43 while dragging the bookmark 43 FIG. 16(d). The controllers 110 and 310 register the operation area C being currently displayed on the touchscreen 391 corresponding to the long tap 44 in the bookmark 2. Thus, the user may select a bookmark 2 and invoke the operation area C onto the touchscreen 391 during another operation, as described below in FIG. 17.

As illustrated in FIG. 17, with the operation area C being displayed as the full screen on the touchscreen 391, the user may perform a long selection, for example, a long tap, on the menu icon 41 disposed at one region of the screen FIG. 17(a). The plurality of bookmark items 42 is displayed on the screen of the touchscreen corresponding to the inputted long tap FIG. 17(b).

The user may conduct a drag operation from the menu icon 41 to one bookmark 45, for example, a bookmark 3, among the bookmark items 42 FIG. 17(c) and release the drag (operation 46), that is, the user conducts a drag and drop operation FIG. 17(c). The controllers 110 and 310 may invoke an area B previously registered in the bookmark 3 corresponding to the drag and drop operation and display the area B on the touchscreen 391 Likewise, the user may conduct a drag and drop operation on the bookmark 2 (43) registered in FIG. 16 to invoke and display the area C.

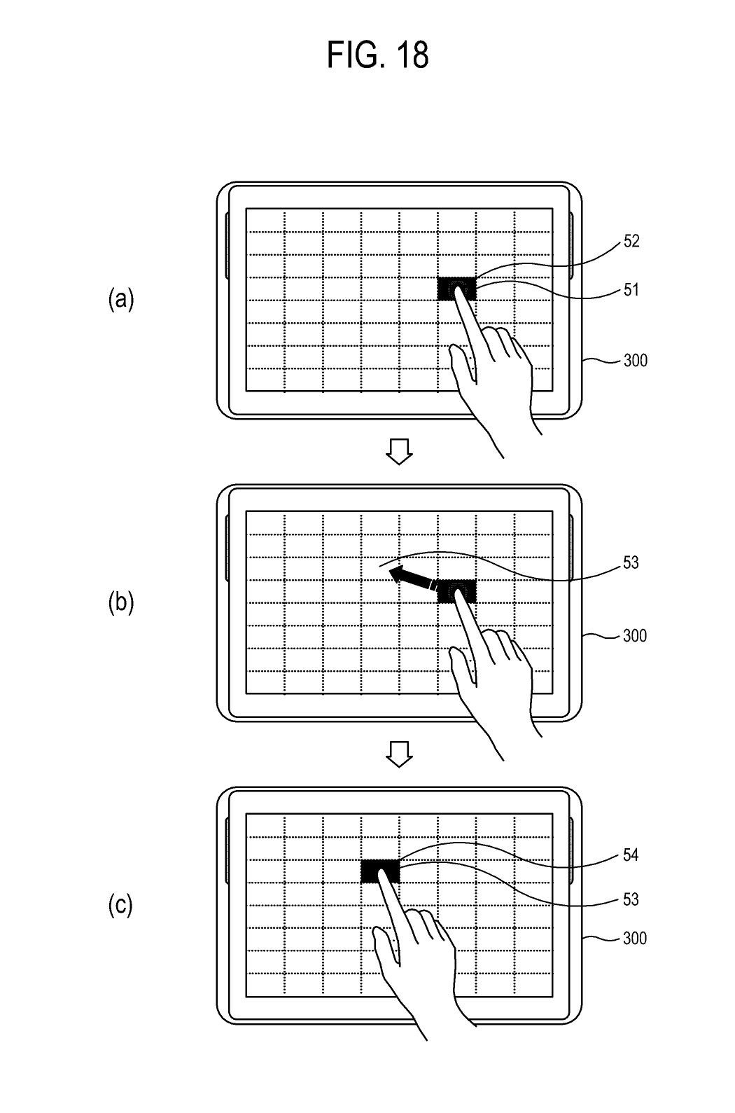

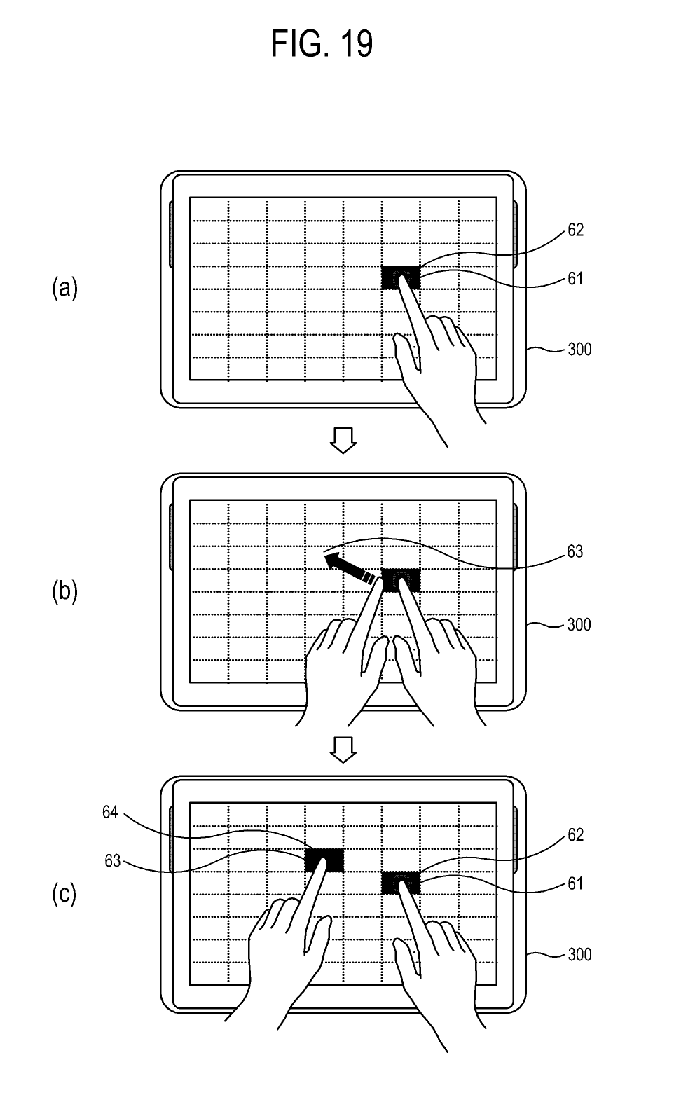

FIGS. 18 and 19 illustrate examples of moving and copying an operation area according to an exemplary embodiment.

As shown in FIG. 18, the user may select or long tap (operation 52) a first location 51 of one of a plurality of operation areas on the touchscreen 391 FIG. 18(a) and move or drag and drop (operation 54) the area to a second location 53 different from the first location FIG. 18(b) and FIG. 18(c). The controllers 110 and 310 move the operation area set in the first location 51 to the second location 53 corresponding to the drag and drop operation using the long tap 52 manipulation.

As shown in FIG. 19, the user may select or long tap (operation 62) a first location 61 of one of a plurality of operation areas on the touchscreen 391 FIG. 19(a) and move or drag and drop (operation 64) the area to a second location 63 different from the first location 61 while holding the touch on the area at the first location FIG. 19(b) and FIG. 19(c). The controllers 110 and 310 copy the operation area set in the first location 61 to the second location 63 corresponding to the drag and drop operation 64 using the long tap operation 62.

Accordingly, the user may move or copy an area through a simple manipulation using a drag and drop on the touchscreen 391.

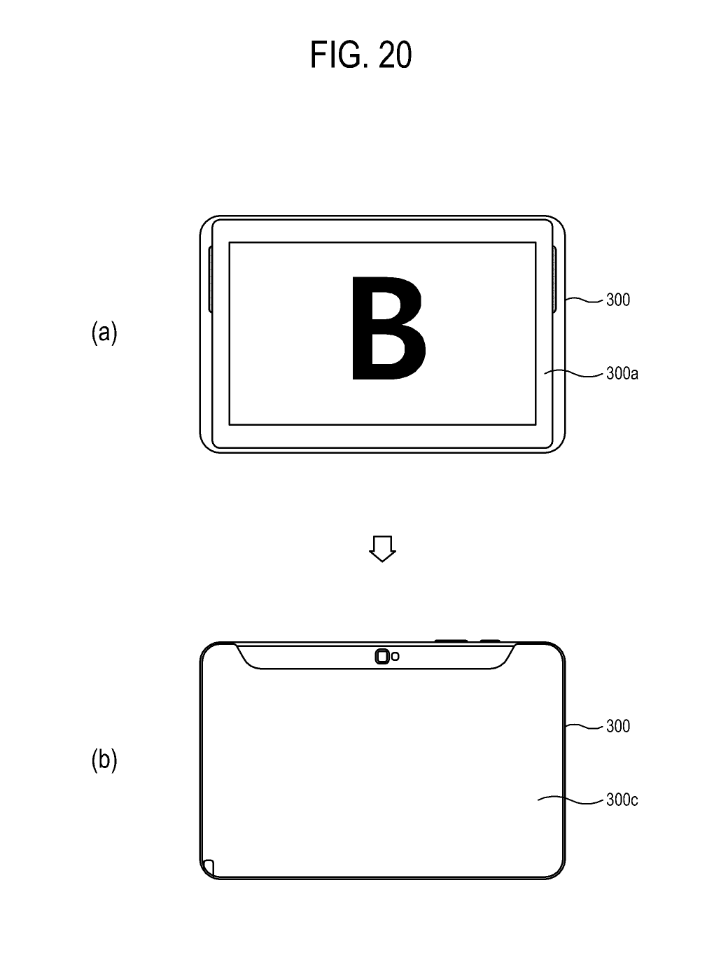

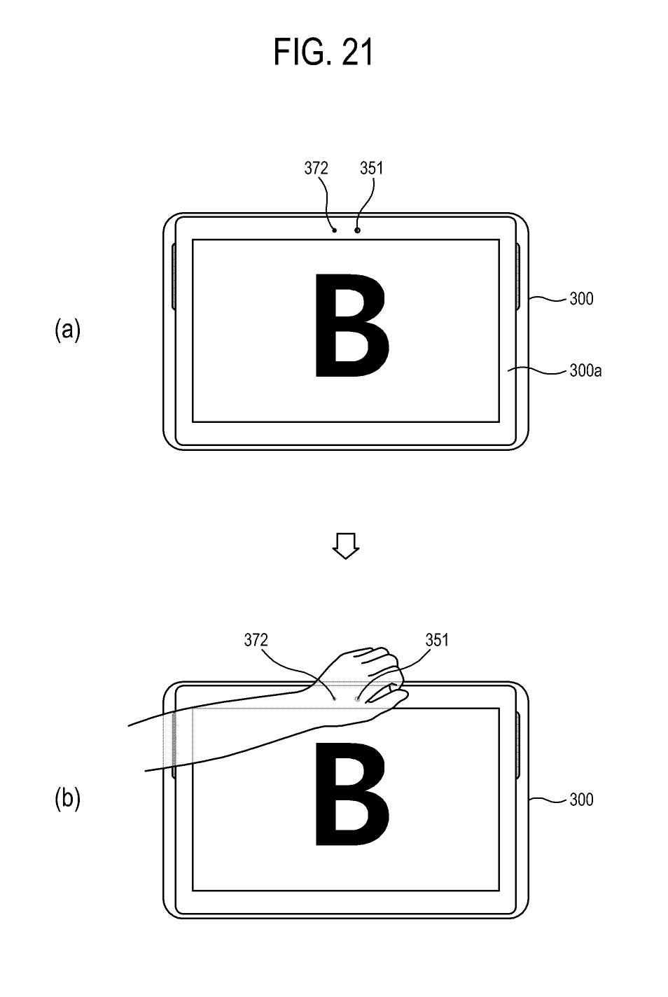

FIGS. 20 and 21 illustrate examples of locking and hiding an operation area according to an exemplary embodiment.

As shown in FIG. 20, the portable device 300 displays an operation area B as a full screen on the touchscreen 391 so that the user may detect using a sensor, for example, a gravity sensor, included in the sensor 370 that the front side 300a and the rear side 300b of the portable device 300 are overturned FIG. 20(b) while working on the operation area B FIG. 20(a). When it is detected that the front side 300a and the rear side 300b are overturned, the second controller 310 transmits a command to lock or hold the area B to adjacent devices, for example, the other portable devices and the display apparatus, through the communication device 330. Locking information on the area B is stored in the first storage 160 or the server as operation area information.

Accordingly, since the area B is placed in a read only state in which a change is unallowable, access to the region B via other devices is restricted, thereby preventing a change due to access by a teacher or student other than a student allocated the area B.

As shown in FIG. 21, the portable device 300 displays an operation area B as a full screen on the touchscreen 391. A luminance sensor 372 detects light around the portable device 300, and the user may block the transmission of light to the luminance sensor 372 of the portable device 300 FIG. 21(b) while working on the operation area B FIG. 21(a). Light transmitted to the luminance sensor may be blocked by covering the luminance sensor 372 with a hand or other object, as shown in FIG. 21, or by attaching a sticker to the luminance sensor 372.

When the luminance sensor 372 detects that the light is blocked, the second controller 310 transmits a command to hide the area B to adjacent devices, for example, the other portable devices and the display apparatus, through the communication device 330. Hidden information on the area B is stored in the first storage 160 or the server 200 as operation area information.

Accordingly, displaying the area B on other devices is restricted, thereby preventing a teacher or student, other than a student allocated the area B, from checking details of the operation.

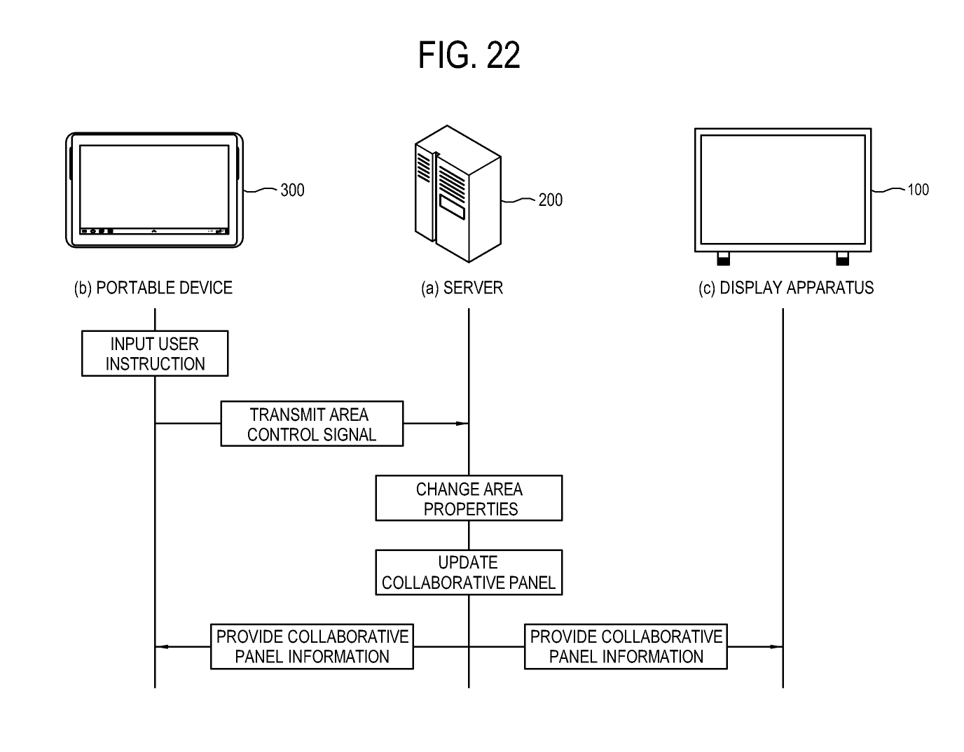

FIG. 22 schematically illustrates a process of transmitting and receiving an area control signal based on a user touch according to an exemplary embodiment.

As shown in FIG. 22, when a user instruction to change properties of an operation area, for example, to register the operation area in a bookmark, to change a location of the operation area, to copy the operation area and to lock or hide the operation area, is input through the portable device 300, information on the changed properties of the area is transmitted as an area control signal to the server 200.

The server 200 changes the pre-stored area information (screen and property information) corresponding to the user instruction and updates the pre-stored collaborative panel information. The server 200 retrieves personal devices 301 and 302 registered in the collaborative panel including the touched area and transmits the updated collaborative panel information to the retrieved devices 301 and 302. The updated collaborative panel information is provided to the portable device 300 and the display apparatus 100. Here, the updated collaborative panel information may be provided to all devices registered for the cooperative learning, for example, the display apparatus 100, the teacher portable device 301 and the student portable devices 302.

The portable device 300 or the display apparatus 100 updates the collaborative panel on the touchscreen 391 based on the received updated collaborative panel information.

When the collaborative panel information is stored in the first storage 160 of the display apparatus 100, the area control signal based on the user instruction through the portable device 300 is transmitted to the display apparatus 100, and the display apparatus 100 may update the collaborative panel information pre-stored in the first storage 160 and provides the updated collaborative panel information to the portable device 300. In the same manner, an area control signal on the collaborative panel performed in the display apparatus may be transmitted and updated, thereby providing updated information to both the portable device 300 and the display apparatus 100.

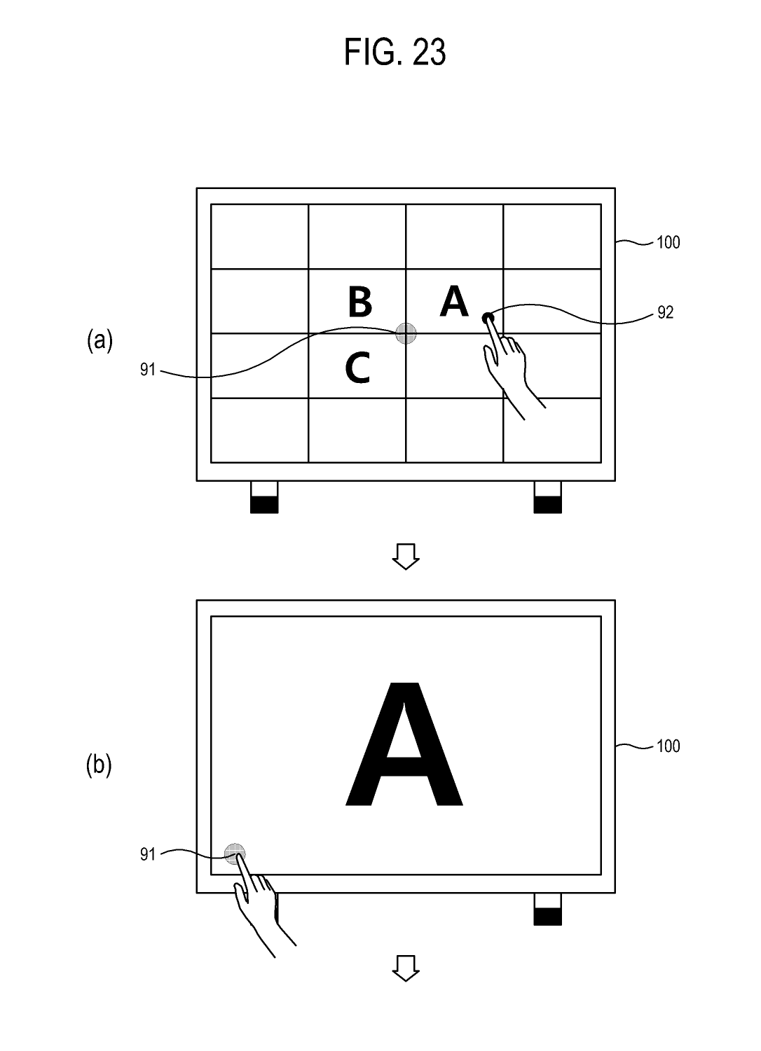

FIGS. 23 to 26 illustrate that the display apparatus displays a screen using a menu icon according to an exemplary embodiment.

As shown in FIG. 23, the display apparatus 100 may control the first display to display a circular menu icon 91 (also referred to as a center ball) at a particular location, for example, in a central area, of the collaborative screen FIG. 23(a).

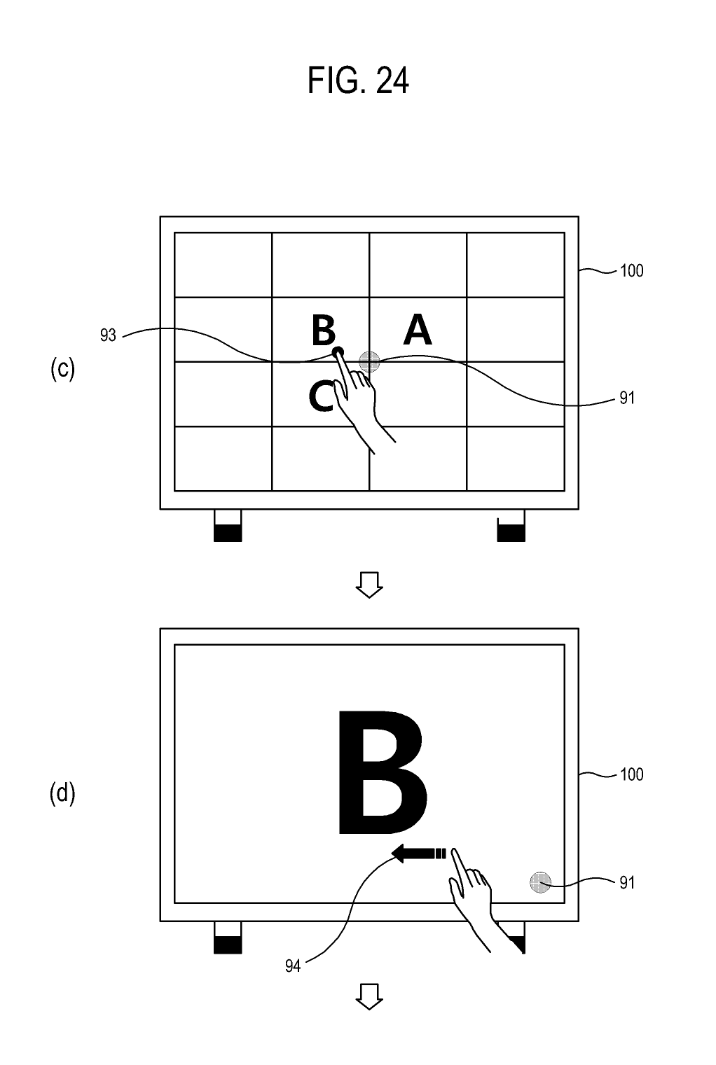

When the user touches or taps an operation area A (operation 92), the first controller 110 enlarges the touched area A to be displayed as a full screen on the first display FIG. 23(b). Here, the menu icon 91 is disposed at a bottom left location corresponding to the location of the enlarged area A. However, the location of the menu icon 91 is not limited thereto. Next, when the user touches or clicks the menu icon 91 at the left bottom location as shown in FIG. 23(b), the first controller 110 controls the first display 130 to display the entire collaborative screen as shown in FIG. 24(c). Likewise, when the user touches or taps an operation area B (operation 93) as shown in FIG. 24(c), the first controller 110 enlarges the touched area B to be displayed as a full screen on the first display 130 FIG. 24(d). Here, the menu icon 91 is disposed at a bottom right location corresponding to the location of the enlarged area B. However, the location of the menu icon 91 is not limited thereto.

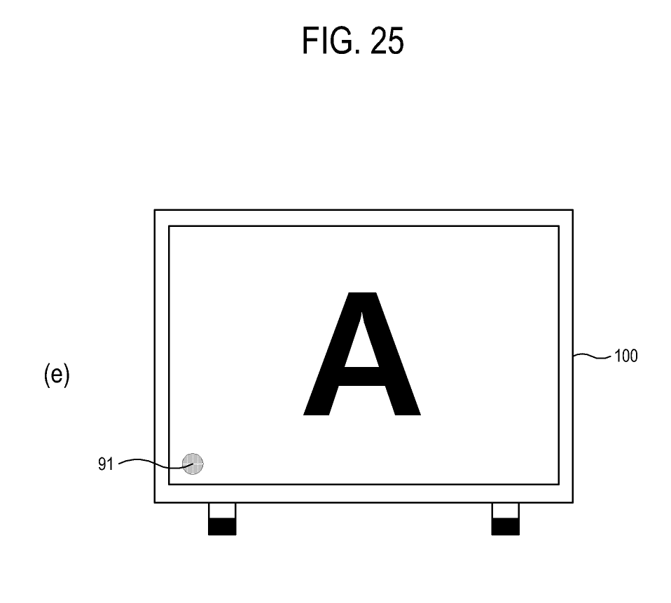

With the operation area B being displayed as the full screen as shown in FIG. 24(d), the user may move the screen on the display corresponding to a moving direction of the touch through a drag or flick manipulation (operation 94) as shown in FIG. 25(e), in order to display a different operation area. That is, as shown in FIG. 25(e), the area B displayed on the screen may be changed to the operation area A disposed on the right of the area B as a drag operation is input with respect to the operation area B in the left direction.

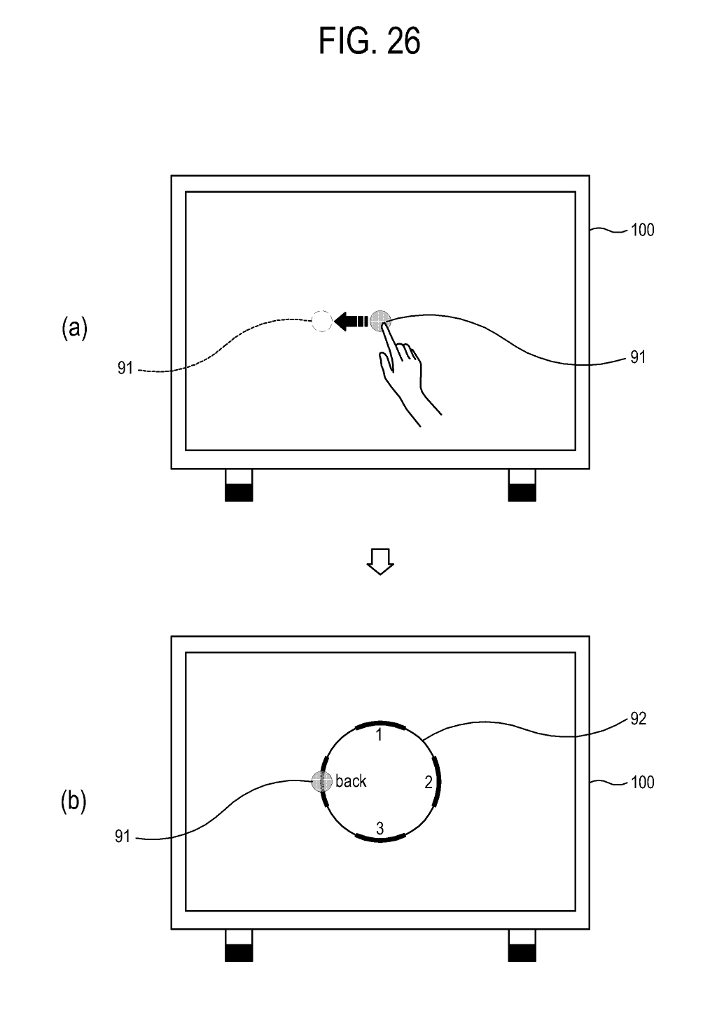

As shown in FIG. 26(a), the user may drag the menu icon 91 displayed on the touchscreen of the display apparatus 100 in a predetermined direction. In FIG. 26(b), a plurality of bookmark items 92 is displayed corresponding to the inputted drag on the touchscreen. Here, a bookmark 1 among the bookmark items 92 may correspond to an operation area which was recently viewed.

The user may conduct a drag operation from the menu icon 91 to one bookmark, for example, a bookmark 2, among the bookmark items 92 FIG. 26(b) and conduct a long tap on the bookmark while dragging the bookmark, thereby registering an operation area being currently performed in the bookmark 2. Further, the user may conduct a drag and drop operation from the menu icon 91 to one bookmark, for example, a bookmark 3, among the bookmark items 92 to select the bookmark 3 and invoke an operation area corresponding to the selected bookmark onto the touchscreen. Accordingly, registering and moving a bookmark may be achieved as well on the display apparatus 100 as illustrated above in FIGS. 16 and 17.

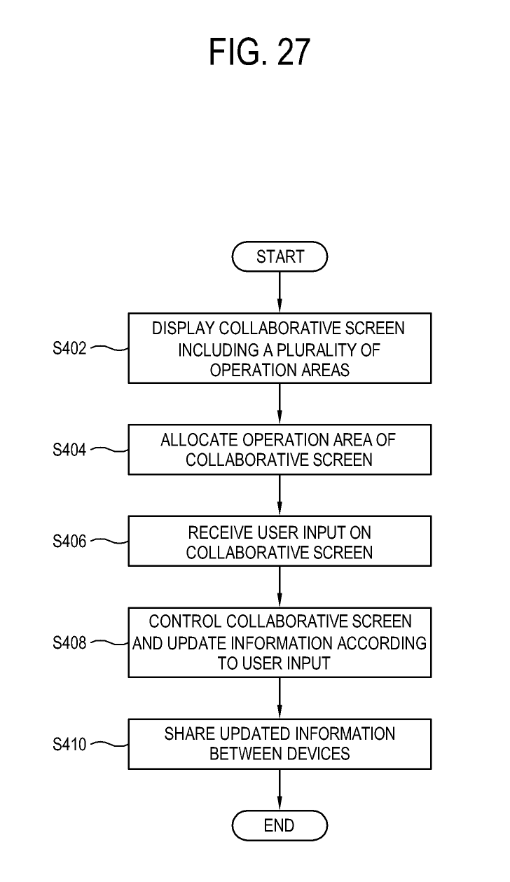

Hereinafter, a screen display method according to an exemplary embodiment will be described with reference to FIG. 27.

FIG. 27 is a flowchart illustrating a screen display method of the display apparatus 100 or the portable device 300 according to an exemplary embodiment.

As shown in FIG. 27, a collaborative screen including a plurality of operation areas may be displayed on the touchscreen 391 of the displays 130 and 390 (operation S402).

The controllers 110 and 310 allocate the operation areas on the collaborative screen to the portable device 302 according to a user instruction (operation S404). Here, operations S402 and S404 may be carried out in the process of generating and allocating the collaborative screen shown in FIGS. 8 to 10, and information on the collaborative screen including the operation areas may be stored in the first storage 160 or the server 200. The controllers 110 and 310 may give notification so that the allocated operation areas are displayed on corresponding portable devices.

The display apparatus 100 or the portable device 300 receives a user touch input on the collaborative screen including the operation areas from the user (operation S406). Here, the received user touch input include inputs based on various user manipulations described above in FIGS. 11 to 26.

The controllers 110 and 310 or touchscreen controller 395 detects a touch based on the user input received in operation S406, controls the collaborative screen corresponding to the detected touch, and updates the information on the stored collaborative screen accordingly (operation S408).

The updated information is shared between registered devices 100, 301 and 302, which participate in cooperative learning (operation S410).

As described above, the exemplary embodiments may share data between a plurality of portable devices or between a portable device and a collaborative display apparatus, display a screen on the display apparatus or a portable device for controlling another portable device, and use the displayed screen of the other portable device.

In detail, the exemplary embodiments may generate a collaborative screen for cooperative learning in an educational environment, detect a touch input to a portable device or display apparatus to control the collaborative screen, and share controlled information between devices, thereby enabling efficient learning.

For example, a teacher may conduct discussions about an area involved in cooperative learning with other students or share an exemplary example of the cooperative learning with the students, thereby improving quality of the cooperative learning. A student may ask for advice on the student's own operation from the teacher or the operation of other students. Also, the teacher may monitor an operation process of a particular area conducted by a student using a teacher portable device, while the student may seek advice on the operation process from the teacher.

In addition, the screen may be controlled in different manners based on various touch inputs to a portable device or a display apparatus, thereby enhancing user convenience.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A screen display method of a display apparatus connectable to a portable device, the method comprising:
displaying a collaborative screen comprising a plurality of operation areas on the display apparatus;
allocating at least one of the operation areas to the portable device;
displaying the collaborative screen with the allocated operation area; and
giving notification to display the allocated operation area on a corresponding portable device.

2. The method of claim 1, further comprising storing collaborative screen information comprising information on the allocated operation area.

3. The method of claim 2, wherein the collaborative screen information is stored in at least one of a storage of the display apparatus and a server connectable to the display apparatus.

4. The method of claim 2, further comprising receiving operation information on the collaborative screen from the portable device, and updating the stored collaborative screen information based on the received operation information.

5. The method of claim 1, further comprising setting a size of the collaborative screen, and generating the collaborative screen based on the set size.

6. The method of claim 1, wherein the plurality of operation areas are allocated to a plurality of portable devices, and a plurality of users corresponding to the portable devices is comprised in one group.

7. The method of claim 1, further comprising detecting a user touch on a screen of a touchscreen of the display apparatus, and controlling the collaborative screen based on the detected touch.

8. The method of claim 7, wherein the controlling of the collaborative screen comprises enlarging or reducing the collaborative screen on the display corresponding to a zoom in or a zoom out manipulation when the user touch is the zoom in or the zoom out manipulation based on a multi-touch.

9. The method of claim 7, wherein the controlling of the collaborative screen comprises moving the collaborative screen on the display in a direction corresponding to a moving direction of the user touch when the user touch is a flick operation or a drag operation.

10. The method of claim 7, wherein the controlling of the collaborative screen comprises moving or copying an operation area set in a first location to a second location when the user touch is a drag and drop operation of the operation areas from a first location to a second location different from the first location.

11. The method of claim 10, wherein the operation area set in the first location is copied to the second location when the user touch is a drag and drop operation from the first location to the second location.

12. The method of claim 7, wherein the controlling of the collaborative screen comprises displaying a first area as a full screen of the display apparatus when the user touch is a tap operation on the first area.

13. The method of claim 12, further comprising displaying the collaborative screen comprising the operation areas on the display apparatus when a menu at a preset location of the collaborative screen is selected in the first area displayed as the full screen.

14. A screen display method of a first portable device connectable to a display apparatus and a second portable device, the method comprising:
displaying a collaborative screen comprising a plurality of operation areas on the first portable device;
allocating at least one of the operation areas to the second portable device;
displaying the collaborative screen with the allocated at least one operation area; and
giving notification to display the allocated operation area on the second portable device.

15. The method of claim 14, further comprising transmitting collaborative screen information comprising information on the allocated at least one operation area.

16. The method of claim 15, wherein the collaborative screen information is transmitted to at least one of the display apparatus and a server managing the collaborative screen information.

17. The method of claim 15, further comprising receiving operation information on the collaborative screen, updating pre-stored collaborative screen information based on the received operation information, and transmitting the updated collaborative screen information.

18. The method of claim 14, further comprising setting a size of the collaborative screen, and generating the collaborative screen based on the set size.

19. The method of claim 14, wherein the plurality of operation areas are allocated to a plurality of portable devices, and a plurality of users corresponding to the portable devices is comprised in one group.

20. The method of claim 14, further comprising detecting a user touch on a screen of a touchscreen of the portable device, and controlling the collaborative screen based on the detected touch.

21. The method of claim 20, wherein the controlling of the collaborative screen comprises enlarging or reducing the collaborative screen on the display corresponding to a zoom in manipulation or a zoom out manipulation when the user touch is the zoom in manipulation or the zoom out manipulation based on a multi-touch.

22. The method of claim 20, wherein the controlling of the collaborative screen comprises moving the collaborative screen on the display in a direction corresponding to a moving direction of the user touch when the user touch is a flick operation or a drag operation.

23. The method of claim 20, wherein the controlling of the collaborative screen comprises moving or copying an operation area set in a first location to a second location when the user touch is a drag and drop manipulation of the operation areas from a first location to a second location different from the first location.

24. The method of claim 23, wherein the operation area set in the first location is copied to the second location when the user touch is a drag and drop operation from the first location to the second location.

25. The method of claim 20, wherein the controlling of the collaborative screen comprises displaying a first area as a full screen of the touch screen when the user touch is a tap operation on the first area.

26. The method of claim 25, further comprising reducing the screen on the display so that a portion of operation areas adjacent to the first area is displayed on the touchscreen when a back button is selected from a menu at a location of the first area displayed as the full screen.

27. The method of claim 20, further comprising receiving a user input on a second area among the operation areas, selecting a menu icon disposed at a location of the touch screen, and registering the second area as a bookmark.

28. The method of claim 27, further comprising displaying a plurality of bookmark items corresponding to the selecting of the menu icon, wherein the registering as the bookmark comprises conducting a drag operation from the menu icon to one of the bookmark items.

29. The method of claim 28, further comprising selecting the menu icon disposed at the location of the touch screen, displaying the plurality of bookmark items corresponding to the selecting of the menu icon, selecting one of the displayed bookmark items, and displaying an operation area corresponding to the selected bookmark item on the touchscreen.

30. The method of claim 20, further comprising receiving a user input on a third area among the operation areas, detecting that a front side and a rear side of the portable device are overturned, and transmitting a command to lock the third area.

31. The method of claim 20, further comprising receiving a user input on a fourth area among the operation areas, detecting that transmission of light to a luminance sensor of the portable device is blocked, and transmitting a command to hide the fourth area.

32. A display apparatus connectable to a first portable device, the display apparatus comprising:
a communication device configured to conduct communications with an external device;
a display configured to display a collaborative screen comprising a plurality of operation areas;
an input device configured to allocate at least one of the operation areas to the portable device; and
a controller configured to control the display to display the collaborative screen with the allocated operation area and configured to control the communication device to give a command to display the allocated operation area on a second portable device.

33. The display apparatus of claim 32, further comprising a storage configured to store collaborative screen information comprising information on the allocated operation area.

34. The display apparatus of claim 33, wherein the communication device is configured to receive operation information on the collaborative screen from the first portable device, and the controller is configured to update the collaborative screen information stored in the storage based on the received operation information.

35. The display apparatus of claim 32, wherein the controller is configured to control the communication device to transmit the collaborative screen information comprising the information on the allocated operation area to a server configured to be connected to the display apparatus.

36. The display apparatus of claim 32, wherein the input device is configured to receive a set size of the collaborative screen, and the controller is configured to generate the collaborative screen based on the set size.

37. The display apparatus of claim 32, wherein the operation area is allocated to a plurality of portable devices, and a plurality of users corresponding to the portable devices is comprised in one group.

38. The display apparatus of claim 32, wherein the controller is configured to detect a user touch on a touchscreen of the display and control the display to control the collaborative screen based on the detected touch.

39. The display apparatus of claim 38, wherein the controller is configured to control the display to enlarge or reduce the collaborative screen on the display corresponding to a zoom in manipulation or a zoom out manipulation when the user touch is the zoom in manipulation or the zoom out manipulation based on a multi-touch.

40. The display apparatus of claim 38, wherein the controller is configured to control the display to move the collaborative screen on the display in a direction corresponding to a moving direction of the user touch when the user touch is a flick operation or a drag operation.

41. The display apparatus of claim 38, wherein the controller controls the display to move or copy an operation area set in a first location to a second location when the user touch is a drag and drop operation of the operation areas from a first location to a second location different from the first location.

42. The display apparatus of claim 41, wherein the controller is configured to control the display to copy the operation area set in the first location to the second location when the user touch is a drag and drop operation from the first location to the second location.

43. The display apparatus of claim 40, wherein the controller is configured to control the display to display a first area as a full screen of the display when the user touch is a tap operation on the first area.

44. The display apparatus of claim 43, wherein the controller is configured to control the display to display the collaborative screen comprising the operation areas on the display apparatus when a menu disposed at a preset location of the collaborative screen is selected in the first area displayed as the full screen.

45. A first portable device connectable to a display apparatus and a second portable device, the first portable device comprising:
a communication device configured to conduct communications with an external device;
a display configured to display a collaborative screen comprising a plurality of operation areas;
an input device configured to allocate at least one of the operation areas to the first portable device; and
a controller configured to control the display to display the collaborative screen with the allocated operation area and configured to control the communication device to give a command to display the allocated operation area on the second portable device.

46. The first portable device of claim 45, wherein the communication device transmits collaborative screen information comprising information on the allocated operation area.

47. The first portable device of claim 46, wherein the collaborative screen information is transmitted to the display apparatus or a server managing the collaborative screen information.

48. The first portable device of claim 46, wherein the input device is configured to receive operation information on the collaborative screen, and the controller is configured to control the display to update and display the pre-stored collaborative screen information based on the received operation information and control the communication device to transmit the updated collaborative screen information.

49. The first portable device of claim 45, wherein the input device is configured to set a size of the collaborative screen, and the controller is configured to generate the collaborative screen based on the set size.

50. The first portable device of claim 45, wherein the operation area is allocated to a plurality of third portable devices, and a plurality of users corresponding to the plurality of third portable devices is comprised in one group.

51. The first portable device of claim 45, wherein the controller comprises a touchscreen controller configured to detect a user touch on a touchscreen of the display and control the collaborative screen corresponding to the detected touch.

52. The first portable device of claim 51, wherein the controller is configured to control the display to enlarge or reduce the collaborative screen on the display corresponding to a zoom in manipulation or a zoom out manipulation when the user touch is the zoom in manipulation or the zoom out manipulation based on a multi-touch.

53. The first portable device of claim 51, wherein the controller is configured to control the display to move the collaborative screen on the display in a direction corresponding to a moving direction of the user touch when the user touch is a flick operation or a drag operation.

54. The first portable device of claim 51, wherein the controller is configured to control the display to move or copy an operation area set in a first location to a second location when the user touch is a drag and drop operation of the operation areas from a first location to a second location different from the first location.

55. The first portable device of claim 54, wherein the controller is configured to control the display to copy the operation area set in the first location to the second location when the user touch is a drag and drop operation from the first location to the second location.

56. The first portable device of claim 51, wherein the controller is configured to control the display to display a first area as a full screen of the touch screen when the user touch is a tap operation on the first area.

57. The first portable device of claim 56, wherein the controller is configured to control the display to reduce the screen on the display so that a portion of operation areas adjacent to the first area is displayed on the touchscreen when a back button is selected through the input device from a menu disposed at a location of the first area displayed as the full screen.

58. The first portable device of claim 51, wherein the controller is configured to register a second area as a bookmark when a user input on the second area among the operation areas is received from the input device and a menu icon disposed at a location of the screen of the touch screen is selected.

59. The first portable device of claim 58, wherein the controller is configured to display a plurality of bookmark items on the display corresponding to the selected menu item, detects a drag operation from the menu icon to one of the bookmark items menu icon, and registers the bookmark.

60. The first portable device of claim 58, wherein the controller is configured to control the display to display the plurality of bookmark items corresponding to the selected menu icon when the menu icon disposed at the location of the touch screen is selected through the input device, and control the display to display an operation area corresponding to the selected bookmark item on the screen of the touchscreen when one of the displayed bookmark items is selected through the input device.

61. The first portable device of claim 45, wherein the controller is configured to control the communication device to transmit a command to lock the operation area displayed on the display when it is detected that a front side of the portable device and a rear side of the portable device are overturned.

62. The first portable device of claim 45, wherein the controller is configured to control the communication device to transmit a command to hide the operation area displayed on the display when it is detected that a transmission of light to a luminance sensor of the portable device is blocked.
